(19) United States
(12) Patent Application Publication
(10) Pub. No.: US 2025/0093740 A1
(43) Pub. Date: Mar. 20, 2025

(54) SIMULTANEOUS SIDEBAND AND DOPPLER LASER COOLING

(71) Applicant: Quantinuum LLC, Broomfield, CO (US)

(72) Inventors: Christopher Newman GILBRETH, Erie, CO (US); John Patrick BARTOLOTTA, Lafayette, CO (US); John Pagnucci GAEBLER, Golden, CO (US)

(21) Appl. No.: 18/887,773

(22) Filed: Sep. 17, 2024

Related U.S. Application Data
(60) Provisional application No. 63/583,357, filed on Sep. 18, 2023.

(51) Int. Cl. G02F 1/35; G06N 10/40

(52) U.S. Cl. CPC G02F 1/3526; G02F 1/3507; G06N 10/40

(57) ABSTRACT

An atomic object confined in a particular region of a confinement apparatus is cooled via a simultaneous sideband and Doppler laser cooling operation. A controller controls first and second manipulation sources to provide first and second two-photon transition manipulation signals to the particular region. The controller controls a third manipulation source to provide a repump manipulation signal to the particular region. The first and second two-photon transition manipulation signals are collectively configured to cause the atomic object to undergo a red sideband transition from a first ground state to a second ground state. The repump manipulation signal is configured to repump the atomic object from the second ground state to the first ground state via an excited state. The repump manipulation signal is red detuned from a transition from the second ground state to the excited state by a repump detuning configured to cause Doppler cooling of the atomic object.

### CROSS-REFERENCE TO RELATED APPLICATIONS

This application claims priority to U.S. Application No. 63/583,357, filed Sep. 18, 2023, the content of which is incorporated herein by reference in its entirety.

### TECHNICAL FIELD

Various embodiments relate to laser cooling of atomic objects confined by an atomic object confinement apparatus. For example, various embodiments relate to laser cooling via sideband and Doppler laser cooling simultaneously. For example, various embodiments relate to sympathetic laser cooling using sideband and Doppler laser cooling simultaneously.

### BACKGROUND

In various scenarios, it is desirable to cool ions trapped by an ion trap such that various operations may be performed on the ions (e.g., experiments, controlled quantum state evolution, and/or the like). However, conventional laser cooling techniques tend to be complicated and/or require high powered laser beams. Some conventional laser cooling techniques are only able to cool ions that are already below a threshold temperature and may actually heat ions that are above the threshold temperature. Through applied effort, ingenuity, and innovation many deficiencies of such conventional laser cooling systems have been solved by developing solutions that are structured in accordance with the embodiments of the present invention, many examples of which are described in detail herein.

### BRIEF SUMMARY OF EXAMPLE EMBODIMENTS

Example embodiments provide quantum computers, atomic systems, controllers, and/or the like and corresponding methods for performing simultaneous sideband and Doppler (SSD) cooling. In various embodiments, the SSD cooling is performed by causing a first two-photon transition manipulation signal, a second two-photon manipulation signal, and a repump manipulation signal to be incident on an atomic object to be cooled. The first two-photon transition manipulation signal and the second two-photon transition manipulation signal are collectively configured to cause the atomic object to undergo a red sideband transition from a first ground state to a second ground state of the atomic object. The repump manipulation signal is configured to repump the atomic object from the second ground state to the first ground state via at least one excited state. In various embodiments, the repump manipulation signal is red detuned from a transition from the second ground state to the at least one excited state by a repump detuning configured to cause Doppler cooling of the atomic object.

In various embodiments, the first two-photon transition manipulation signal is detuned from the at least one excited state by a single photon detuning. In various embodiments, the laser cooling is performed in a near detuned regime where the single photon detuning is relatively small (e.g., 0.5 to 200 times or 0.5 to 500 times the linewidth of the at least one excited state). In various embodiments, when performing laser cooling in the near detuned regime, the first two-photon transition manipulation signal, the second two-photon transition manipulation signal, and/or the repump manipulation signal are provided to the atomic object as sheet beams.

According to one aspect, a method for cooling an atomic object confined by a confinement apparatus using SSD cooling is provided. In an example embodiment, the method includes controlling, by a controller associated with the confinement apparatus, a first manipulation source to provide a first two-photon transition manipulation signal to a particular region of the confinement apparatus; controlling, by the controller, a second manipulation source to provide a second two-photon transition manipulation signal to the particular region of the confinement apparatus; and controlling, by the controller, a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. The at least one repump manipulation signal is red detuned from a transition from the second ground state to the at least one excited state by a repump detuning. The repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, a single photon detuning is a detuning between the first two-photon transition manipulation signal and the at least one excited state and the single photon detuning is in a range of 0.5 to 200 times or 0.5 to 500 times the linewidth of the at least one excited state.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal cool the atomic object via continuous sideband cooling and Doppler cooling.

In an example embodiment, a single photon detuning is a detuning between the first two-photon transition manipulation signal and the at least one excited state and the single photon detuning is in a range of 500 to 100,000 times the linewidth of the at least one excited state and the first two-photon transition manipulation signal, the second two-photon transition manipulation signal, and the at least one repump manipulation signal are provided as focused laser beams.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, a single photon detuning is a detuning between the first two-photon transition manipulation signal and the at least one excited state, for a first time period (e.g., a first cooling time), the single photon detuning is in a range of 0.5 to 100 times the linewidth of the at least one excited state, and for a second time period (e.g., a second cooling time), the single photon detuning is in a range of 500 to 100,000 times the linewidth of the at least one excited state.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

According to another aspect, a method for cooling an atomic object confined by a confinement apparatus using near detuned SSD cooling is provided. In an example embodiment, the method includes controlling, by a controller associated with the confinement apparatus, a first manipulation source to provide a first two-photon transition manipulation signal to a particular region of the confinement apparatus; controlling, by the controller, a second manipulation source to provide a second two-photon transition manipulation signal to the particular region of the confinement apparatus; and controlling, by the controller, a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. A single photon detuning is a detuning between the first two-photon transition manipulation signal and the at least one excited state. The single photon detuning is in a range of 0.5 to 100 times a linewidth of the at least one excited state.

In an example embodiment, the at least one repump manipulation signal is red detuned from a transition from the second ground state to the at least one excited state by a repump detuning, and the repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal are configured to cool the atomic object via continuous sideband cooling and Doppler cooling simultaneously.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, the first two-photon transition manipulation signal, the second two-photon transition manipulation signal, and the at least one repump manipulation signal are configured to cool multiple motional modes of the object crystal simultaneously.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

According to another aspect, an atomic system configured for performing an SSD cooling operation is provided. In an example embodiment, the atomic system includes a first manipulation source configured to generate and provide a first two-photon transition manipulation signal; a second manipulation source configured to generate and provide a second two-photon transition manipulation signal; a third manipulation source configured to generate and provide at least one repump manipulation signal; a confinement apparatus configured to confine an atomic object; and a controller configured to control operation of the first manipulation source, the second manipulation source, and the third manipulation source. The controller is configured to perform controlling a first manipulation source to provide a first two-photon transition manipulation signal to a particular region of the confinement apparatus; controlling a second manipulation source to provide a second two-photon transition manipulation signal to the particular region of the confinement apparatus; and controlling a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. The at least one repump manipulation signal is red detuned from a transition from the second ground state to the at least one excited state by a repump detuning. The repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, a single photon detuning is a detuning between the first two-photon transition manipulation signal and the at least one excited state and the single photon detuning is in a range of 0.5 to 200 times or 0.5 to 500 times the linewidth of the at least one excited state.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal cool the atomic object via continuous sideband cooling and Doppler cooling.

In an example embodiment, a single photon detuning is a detuning between the first two-photon transition manipulation signal and the at least one excited state and the single photon detuning is in a range of 500 to 100,000 times the linewidth of the at least one excited state and the first two-photon transition manipulation signal, the second two-photon transition manipulation signal, and the at least one repump manipulation signal are provided as focused laser beams.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, a single photon detuning is a detuning between the first two-photon transition manipulation signal and the at least one excited state, for a first time period (e.g., a first cooling time), the single photon detuning is in a range of 0.5 to 100 times the linewidth of the at least one excited state, and for a second time period (e.g., a second cooling time), the single photon detuning is in a range of 500 to 100,000 times the linewidth of the at least one excited state.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

According to another aspect, an atomic system configured for performing a near detuned SSD cooling operation is provided. In an example embodiment, the atomic system includes a first manipulation source configured to generate and provide a first two-photon transition manipulation signal; a second manipulation source configured to generate and provide a second two-photon transition manipulation signal; a third manipulation source configured to generate and provide at least one repump manipulation signal; a confinement apparatus configured to confine an atomic object; and a controller configured to control operation of the first manipulation source, the second manipulation source, and the third manipulation source. The controller is configured to perform controlling a first manipulation source to provide a first two-photon transition manipulation signal to a particular region of the confinement apparatus; controlling a second manipulation source to provide a second two-photon transition manipulation signal to the particular region of the confinement apparatus; and controlling a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. A single photon detuning is a detuning between the first two-photon transition manipulation signal and the at least one excited state. The single photon detuning is in a range of 0.5 to 100 times a linewidth of the at least one excited state.

In an example embodiment, the at least one repump manipulation signal is red detuned from a transition from the second ground state to the at least one excited state by a repump detuning, and the repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal are configured to cool the atomic object via continuous sideband cooling and Doppler cooling simultaneously.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, the first two-photon transition manipulation signal, the second two-photon transition manipulation signal, and the at least one repump manipulation signal are configured to cool multiple motional modes of the object crystal simultaneously.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

According to another aspect, controller configured to cause performance of an SSD cooling operation is provided. In an example embodiment, the controller includes a processing device, memory storing executable instructions, and one or more driver controller elements, the executable instructions configured to, when executed by the processing device, cause the controller to use the one or more driver controller elements to control operation of a first manipulation source, second manipulation source, and third manipulation source to perform controlling a first manipulation source to provide a first two-photon transition manipulation signal to a particular region of the confinement apparatus; controlling a second manipulation source to provide a second two-photon transition manipulation signal to the particular region of the confinement apparatus; and controlling a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. The at least one repump manipulation signal is red detuned from a transition from the second ground state to the at least one excited state by a repump detuning. The repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, a single photon detuning is a detuning between the first two-photon transition manipulation signal and the at least one excited state and the single photon detuning is in a range of 0.5 to 200 times or 0.5 to 500 times the linewidth of the at least one excited state.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal cool the atomic object via continuous sideband cooling and Doppler cooling.

In an example embodiment, a single photon detuning is a detuning between the first two-photon transition manipulation signal and the at least one excited state and the single photon detuning is in a range of 500 to 100,000 times the linewidth of the at least one excited state and the first two-photon transition manipulation signal, the second two-photon transition manipulation signal, and the at least one repump manipulation signal are provided as focused laser beams.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, a single photon detuning is a detuning between the first two-photon transition manipulation signal and the at least one excited state, for a first time period (e.g., a first cooling time), the single photon detuning is in a range of 0.5 to 100 times the linewidth of the at least one excited state, and for a second time period (e.g., a second cooling time), the single photon detuning is in a range of 500 to 100,000 times the linewidth of the at least one excited state.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

According to another aspect, controller configured to cause performance of a near detuned SSD cooling operation is provided. In an example embodiment, the controller includes a processing device, memory storing executable instructions, and one or more driver controller elements, the executable instructions configured to, when executed by the processing device, cause the controller to use the one or more driver controller elements to control operation of a first manipulation source, second manipulation source, and third manipulation source to perform controlling a first manipulation source to provide a first two-photon transition manipulation signal to a particular region of the confinement apparatus; controlling a second manipulation source to provide a second two-photon transition manipulation signal to the particular region of the confinement apparatus; and controlling a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. A single photon detuning is a detuning between the first two-photon transition manipulation signal and the at least one excited state. The single photon detuning is in a range of 0.5 to 100 times a linewidth of the at least one excited state.

In an example embodiment, the at least one repump manipulation signal is red detuned from a transition from the second ground state to the at least one excited state by a repump detuning, and the repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal are configured to cool the atomic object via continuous sideband cooling and Doppler cooling simultaneously.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, the first two-photon transition manipulation signal, the second two-photon transition manipulation signal, and the at least one repump manipulation signal are configured to cool multiple motional modes of the object crystal simultaneously.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

According to another aspect, a computer program product configured to, when executed by a processing device of a controller of an atomic system, cause performance of an SSD cooling operation is provided. In an example embodiment, the computer program product includes at least one non-transitory storage medium storing computer executable instructions, the executable instructions configured to, when executed by a controller cause the controller to control a first manipulation source to provide a first two-photon transition manipulation signal to a particular region of the confinement apparatus; control a second manipulation source to provide a second two-photon transition manipulation signal to the particular region of the confinement apparatus; and control a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. The at least one repump manipulation signal is red detuned from a transition from the second ground state to the at least one excited state by a repump detuning. The repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, a single photon detuning is a detuning between the first two-photon transition manipulation signal and the at least one excited state and the single photon detuning is in a range of 0.5 to 200 times or 0.5 to 500 times the linewidth of the at least one excited state.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal cool the atomic object via continuous sideband cooling and Doppler cooling.

In an example embodiment, a single photon detuning is a detuning between the first two-photon transition manipulation signal and the at least one excited state and the single photon detuning is in a range of 500 to 100,000 times the linewidth of the at least one excited state and the first two-photon transition manipulation signal, the second two-photon transition manipulation signal, and the at least one repump manipulation signal are provided as focused laser beams.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, a single photon detuning is a detuning between the first two-photon transition manipulation signal and the at least one excited state, for a first time period (e.g., a first cooling time), the single photon detuning is in a range of 0.5 to 100 times the linewidth of the at least one excited state, and for a second time period (e.g., a second cooling time), the single photon detuning is in a range of 500 to 100,000 times the linewidth of the at least one excited state.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

According to another aspect, a computer program product configured to, when executed by a processing device of a controller of an atomic system, cause performance of a near detuned SSD cooling operation is provided. In an example embodiment, the computer program product includes at least one non-transitory storage medium storing computer executable instructions, the executable instructions configured to, when executed by a controller cause the controller to control a first manipulation source to provide a first two-photon transition manipulation signal to a particular region of the confinement apparatus; control a second manipulation source to provide a second two-photon transition manipulation signal to the particular region of the confinement apparatus; and control a third manipulation source to provide at least one repump manipulation signal to the particular region of the confinement apparatus. The atomic object to be cooled is located in the particular region of the confinement apparatus. The first two-photon transition manipulation signal and the second two-photon transition manipulation signal are collectively configured to cause the atomic object to undergo a red sideband transition from a first ground state to a second ground state of the atomic object. The at least one repump manipulation signal is configured to repump the atomic object from the second ground state to the first ground state via at least one excited state. A single photon detuning is a detuning between the first two-photon transition manipulation signal and the at least one excited state. The single photon detuning is in a range of 0.5 to 100 times a linewidth of the at least one excited state.

In an example embodiment, the at least one repump manipulation signal is red detuned from a transition from the second ground state to the at least one excited state by a repump detuning, and the repump detuning is in a range of 0.2 to 10 times a linewidth of the at least one excited state.

In an example embodiment, at least one of the first two-photon transition manipulation signal, the second two-photon transition manipulation signal, or the at least one repump manipulation signal are provided as sheet beams.

In an example embodiment, the atomic object is one of a plurality of atomic objects confined by the confinement apparatus, the particular region is one of a plurality of regions defined at least in part by the confinement apparatus, the plurality of atomic objects are confined at one or more respective regions of the plurality of regions of the confinement apparatus, and the first two-photon transition manipulation signal, the second two-photon transition manipulation signal, and the at least one repump manipulation signal are collectively configured to cool the plurality of atomic objects simultaneously.

In an example embodiment, respective intensities of the first two-photon manipulation signal, the second two-photon manipulation signal, the at least one repump manipulation signal, and the repump detuning are configured to enable multiple motional modes of the atomic object to be cooled simultaneously.

In an example embodiment, collectively the first two-photon transition manipulation signal, the second two-photon transition manipulation signal, and the at least one repump manipulation signal are configured to cool the atomic object via continuous sideband cooling and Doppler cooling simultaneously.

In an example embodiment, the first two-photon transition manipulation signal and the second two-photon transition manipulation signal are not co-propagating.

In an example embodiment, the atomic object is part of an object crystal comprising the atomic object and a qubit object and the atomic object is configured to sympathetically cool the qubit object.

In an example embodiment, the first two-photon transition manipulation signal, the second two-photon transition manipulation signal, and the at least one repump manipulation signal are configured to cool multiple motional modes of the object crystal simultaneously.

In an example embodiment, the at least one repump manipulation signal includes a first manipulation signal that is characterized by a wavelength that is resonant with a first repump transition and a second manipulation signal that is characterized by a wavelength that is red detuned from a second repump transition.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides block diagram of an example atomic system, in accordance with an example embodiment.

FIG. 2 provides a level diagram of an atomic object illustrating performance of a simultaneous sideband and Doppler (SSD) cooling operation, in accordance with an example embodiment.

FIG. 3A provides a level diagram of an atomic object having a half integer nuclear spin illustrating performance of a SSD cooling operation, in accordance with an example embodiment.

FIG. 3B provides the level diagram shown in FIG. 3A, but only shows the first two photon transition manipulation signals, in accordance with an example embodiment.

FIG. 3C provides the level diagram shown in FIG. 3A, but only shows the second two photon transition manipulation signals, in accordance with an example embodiment.

FIG. 3D provides the level diagram shown in FIG. 3A, but only include the repump manipulation signals, in accordance with an example embodiment.

FIG. 3E provides a schematic diagram illustrating performance of an SSD cooling operation corresponding to the level diagram shown in FIG. 3A, in accordance with example embodiment.

FIG. 4A provides a level diagram of an atomic object having an integer nuclear spin illustrating performance of a SSD cooling operation using only linear polarized manipulation signals, in accordance with an example embodiment.

FIG. 4B provides a schematic diagram illustrating performance of an SSD cooling operation corresponding to the level diagram shown in FIG. 4A, in accordance with example embodiment.

FIG. 5A provides a level diagram of an atomic object having an integer nuclear spin illustrating performance of a SSD cooling operation using linear and circular polarized manipulation signals, in accordance with an example embodiment.

FIG. 5B provides a schematic diagram illustrating performance of an SSD cooling operation corresponding to the level diagram shown in FIG. 5A, in accordance with example embodiment.

FIG. 6 provides a flowchart illustrating various processes and/or procedures performed by a controller of an atomic system to cause performance of an SSD cooling operation, in accordance with an example embodiment.

FIG. 7 provides a schematic diagram of an example controller of a quantum computer comprising an atomic object confinement apparatus configured for confining atomic objects therein, in accordance with an example embodiment.

FIG. 8 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within applicable engineering and/or manufacturing tolerances and/or within user measurement capabilities, unless otherwise indicated. Like numbers refer to like elements throughout.

In various scenarios, atomic objects are confined by a confinement apparatus. In various embodiments, the confinement apparatus is an ion trap, such as a surface ion trap, Paul ion trap, and/or the like. In various embodiments, the atomic objects are neutral or charged atoms; neutral, charged, or multipolar molecules; and/or other particles having energy structures that can be cooled via laser cooling; and/or the like. In an example embodiment, the confinement apparatus is configured to confine qubit objects and atomic objects. For example, the qubit objects and atomic objects are confined as object crystals including at least one qubit object and at least one atomic object, in various embodiments. For example, the atomic objects are used to sympathetically cool the qubit objects, in various embodiments. For example, in various embodiments, the atomic objects are ions of a first atomic number and/or first chemical element and the qubit objects are ions of a second atomic number and/or a second chemical element that is different from the first atomic number and/or first chemical element.

In various embodiments, the confinement apparatus is part of an atomic system. In various embodiments, the atomic system is a quantum charge-coupled device (QCCD)-based quantum computer, and the qubit objects are used as qubits of the QCCD-based quantum computer. For example, the quantum objects confined within the confinement apparatus are used to perform experiments, controlled quantum state evolution, quantum computations, and/or the like, in various embodiments. In various embodiments, in order for the qubit objects confined within the confinement apparatus to be used to perform the experiments, controlled quantum state evolution, quantum computations, and/or the like, the qubit objects need to be at a low temperature and/or cooled near the motional ground state of the qubit object.

In various embodiments, laser cooling is used to reduce the motional energy of atomic objects confined by the confinement apparatus. The atomic objects may be used to sympathetically cool the qubit objects. For example, for a first object crystal including a first atomic object and a first qubit object, the first atomic object is cooled via laser cooling and used to sympathetically cool the first qubit object.

Conventional types of laser cooling include Doppler cooling, resolved sideband cooling, and electromagnetically induced transparency (EIT) cooling. However, Doppler cooling is not able to cool to sufficiently low temperatures for various applications. Conventional sideband cooling requires higher laser intensity than Doppler cooling or EIT cooling. In particular, conventional sideband cooling requires use of pencil and/or focused beams due to the required high laser intensity. This high laser intensity results in high levels of power consumption and significant wear on optical components of the system. Conventional sideband cooling also requires parameters that are tuned to the temperature of the atomic objects to cause efficient cooling. EIT cooling causes heating of atomic objects that are above a threshold temperature known as the “capture temperature,” which can lead to atomic objects and/or qubit objects being lost from the confinement apparatus. Moreover, while Doppler cooling and EIT are capable of multiple mode cooling, conventional sideband cooling is a single-mode cooling process. For example, for cooling multiple modes of the atomic objects and/or object crystals, conventional sideband cooling requires a series of single mode cooling operations, each with a distinct set of parameters.

As a result of EIT cooling's inability to cool atomic objects and/or object crystals having a temperature greater than the capture temperature and the technical demands associated with conventional sideband cooling, laser cooling is often performed as a multiple step process. For example, Doppler cooling may be used first to cool atomic objects and/or object crystals. However, as Doppler cooling cannot cool to sufficiently low temperatures for various applications, a second round of cooling using EIT cooling and/or conventional sideband cooling is used to cool atomic objects and/or object crystals to close to their motional ground state. Thus, conventional laser cooling techniques tend to be slow, technically challenging, and require multiple sets of parameters for cooling atomic objects and/or object crystals at different temperatures. Therefore, technical problems exist regarding how to laser cool atomic objects and/or object crystals efficiently in terms of time and energy consumption (e.g., power required to operate the lasers and/or manipulation sources). Additionally, the cost of the laser and/or amplification systems required for providing large amounts of laser power and the technical challenges of providing high power laser beams provide further technical problems. Moreover, technical problems exit regarding how to laser cool atomic objects and/or object crystals across a wide range of temperatures in a time and/or energy efficient manner.

Various embodiments provide technical solutions to these technical problems. For example, various embodiments provide a simultaneous sideband and Doppler (SSD) cooling technique. SSD cooling enables cooling of atomic objects and/or object crystals across a wide range of temperatures using a single set of parameters. For example, in various embodiments atomic objects and/or object crystals are quickly cooled from high temperatures resulting from collisions with background gas molecules to sub-Doppler temperatures (e.g., temperatures below the Doppler cooling limit) using a single set of parameters. Additionally, in various embodiments, the first two-photon transition manipulation signal, second two-photon transition manipulation signal, and repump manipulation signal are provided as sheet beams.

As used herein, a sheet beam is a large aspect ratio laser beam meant to simultaneously address all the atomic objects and/or object crystals confined within one or more respective regions of the confinement apparatus, or confined by the confinement apparatus as a whole, by propagating across a surface of the confinement apparatus. In certain embodiments, a sheet beam is a laser beam that has been spatially broadened so as to address and/or be incident on multiple regions of the confinement apparatus. For example, the sheet beam may be a laser beam that has been spatially broadened such that atomic objects in different regions of the confinement apparatus experience a similar laser intensity. For example, a sheet beam is a wide beam (e.g., possibly millimeters to centimeters wide) configured to be incident on a plurality of atomic objects and/or object crystals as the sheet beam propagates across a surface of the confinement apparatus. For example, in various embodiments, a sheet beam has an aspect ratio (e.g., width of the beam in a first direction perpendicular to the propagation direction of the beam to the waist beam/width of the beam in a second direction that is perpendicular to the propagation direction and to the first direction) that is greater than 8:1 (e.g., 10:1 or greater). In an example embodiment, the aspect ratio of a sheet beam is 500:1. The large aspect ratio of the sheet beam enables a large number of atomic objects and/or object crystals to be cooled to sub-Doppler temperatures simultaneously with moderate laser power.

Moreover, in various embodiments, multiple motional modes of the atomic object and/or object crystal may be cooled simultaneously (which is not an available option for conventional sideband cooling). In certain embodiments, individual motional modes are cooled in serial using red-detuned repump manipulation signals such that various motional modes are cooled individually at a faster rate than the conventional cooling rate. As such, various embodiments provide cooling operations that are more time efficient than conventional cooling operations cooling. Therefore, various embodiments provide improvements to the technical fields of laser cooling, atomic systems that use laser cooling, and quantum computing.

### Example Atomic System

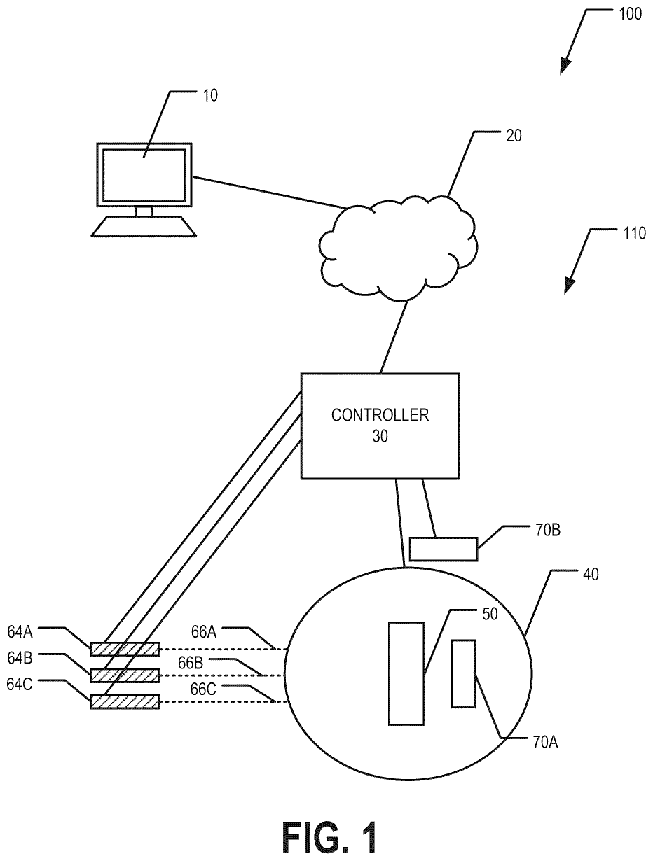

Laser cooling of atomic objects and/or object crystals confined by a confinement apparatus may be performed in a wide variety of contexts and/or for a wide variety of applications. For example, many atomic systems may use laser cooling to cool atomic objects and/or object crystals confined by a confinement apparatus (e.g., Paul trap, surface trap, optical trap, magnetic trap, magneto-optical trap (MOT), and/or the like). One example of such an atomic system is quantum charge-coupled device (QCCD)-based quantum computer. FIG. 1 provides a block diagram of an example quantum system 100 including a QCCD-based quantum computer. In various embodiments, the quantum system 100 comprises a computing entity 10 and a quantum computer 110.

In various embodiments, the quantum computer 110 comprises a controller 30, a cryogenic and/or vacuum chamber 40 enclosing a confinement apparatus 50 having atomic objects confined thereby, and one or more manipulation sources 64 (e.g., 64A, 64B, 64C). In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic objects and/or qubit objects confined by the confinement apparatus 50.

In various embodiments, the controller 30 is configured to control operation of respective manipulation sources 64 to cause the respective manipulation sources to generate and/or provide respective manipulation signals. For example, a first manipulation source 64A is configured to generate and/or provide a first two-photon transition manipulation signal, a second manipulation source 64B is configured to generate and/or provide a second two-photon transition manipulation signal, and a third manipulation source 64C is configured to generate and/or provide a repump manipulation signal. The first two-photon transition manipulation signal, second two-photon manipulation signal, and repump manipulation signal are configured to collectively laser cool atomic objects and/or object crystals confined by the confinement apparatus using SSD laser cooling.

In various embodiments, the first manipulation source 64A, the second manipulation source 64B, and the third manipulation source 64C may collectively include one or more lasers. For example, in an example embodiment, the first manipulation source 64A, the second manipulation source 64B, and the third manipulation source 64C collectively comprise one laser. The output of the one laser is split into three split beams with each of the three split beams modified (e.g., frequency modulated and/or modified, polarization modified, intensity modified, linewidth modified, and/or the like) as appropriate by the respective manipulation source 64 to provide a respective manipulation signal. In another example embodiment, the first manipulation source 64A, the second manipulation source 64B, and the third manipulation source 64C collectively comprise two lasers from which the first manipulation source 64A, the second manipulation source 64B, and the third manipulation source 64C generate the first two-photon transition manipulation signal, second two-photon manipulation signal, and repump manipulation signal. In another example embodiment, each of the first manipulation source 64A, the second manipulation source 64B, and the third manipulation source 64C includes a respective laser such that the first manipulation source 64A, the second manipulation source 64B, and the third manipulation source 64C collectively include three lasers.

In various embodiments, the confinement apparatus 50 is an ion trap, such as a surface ion trap, Paul ion trap, and/or the like. In various embodiments, the confinement apparatus 50 is an optical trap, magnetic trap, magneto-optical trap (MOT), and/or the like. In various embodiments, the atomic objects and/or qubit objects are neutral or charged atoms; neutral, charged, or multipolar molecules; and/or other particles having energy structures that can be cooled via laser cooling; and/or the like. An object crystal comprises at least one atomic object and at least one qubit object. For example, in an example embodiment, the atomic object is one of a singly ionized Ba atom or a singly ionized Yb atom and the qubit object is the other of a singly ionized Ba atom or a singly ionized Yb atom. Various other combinations of atomic objects and qubit objects may be used in various embodiments, as appropriate for the application.

In an example embodiment, the one or more manipulation sources 64 each provide a respective manipulation signal (e.g., laser beam and/or the like) to one or more regions of the confinement apparatus 50 via corresponding beam path systems 66 (e.g., 66A, 66B, 66C). In various embodiments, at least one beam path system 66 comprises a modulator configured to modulate the manipulation signal being provided to the confinement apparatus 50 via the beam path system 66. In various embodiments, the manipulation sources 64, modulator, and/or other components of the beam path systems 66 are controlled by the controller 30.

In various embodiments, the quantum computer 110 comprises one or more magnetic field generators 70 (e.g., 70A, 70B). For example, the magnetic field generator may be an internal magnetic field generator 70A disposed within the cryogenic and/or vacuum chamber 40 and/or an external magnetic field generator 70B disposed outside of the cryogenic and/or vacuum chamber 40. In various embodiments, the magnetic field generators 70 are permanent magnets, Helmholtz coils, electrical magnets, and/or the like. In various embodiments, the magnetic field generators 70 are configured to generate a magnetic field at one or more regions of the confinement apparatus 50 that has a particular magnitude and a particular magnetic field direction in the one or more regions of the confinement apparatus 50.

In various embodiments, the controller 30 is configured to control voltage sources, electrical signal sources, and/or drivers controlling the confinement apparatus 50 and/or transport of object crystals within the confinement apparatus 50, a cryogenic system and/or vacuum system controlling the temperature and pressure within the cryogenic and/or vacuum chamber 40, manipulation sources 64, magnetic field generators 70, beam path systems 66, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more atomic objects and/or qubit objects confined by the confinement apparatus 50.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, quantum circuits, and/or the like into a computing language, executable instructions, command sets, and/or the like that the controller 30 can understand and/or implement.

### Example SSD Cooling Operations

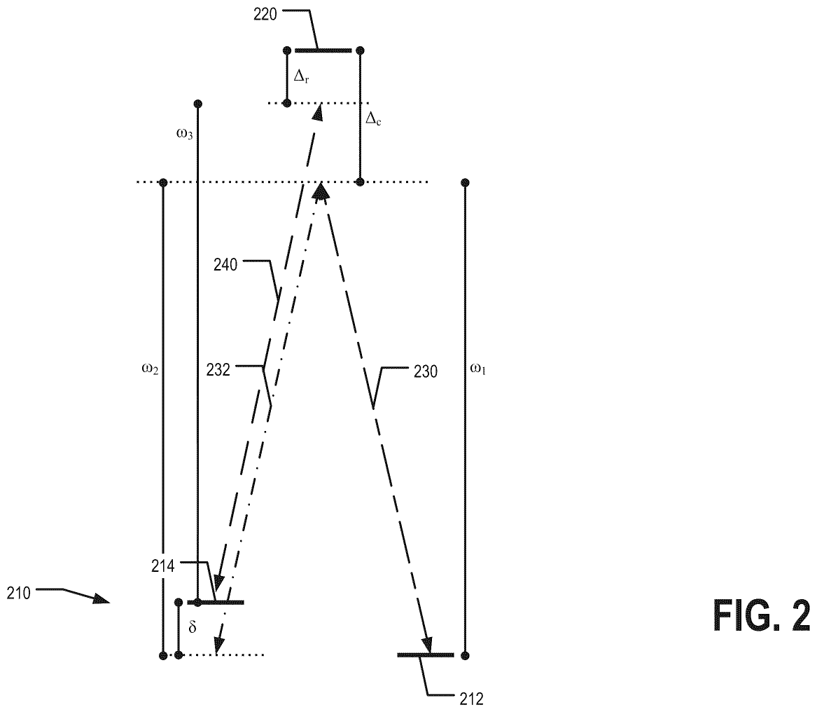

Various embodiments provide quantum computers, atomic systems, controller of quantum computers and/or atomic systems, computer program products, and/or the like and corresponding methods for performing SSD cooling. FIG. 2 provides a level diagram of an example atomic object and illustrates an example of SSD cooling for the atomic object. In the illustrated example embodiment, the energy structure of the atomic object includes a ground state manifold 210 including a first ground state 212 and a second ground state 214 and an excited state 220.

Performing an SSD cooling operation on an atomic object includes causing a first two-photon transition manipulation signal 230 (shown as a long dash -short dash line) and a second two-photon transition manipulation signal 232 (shown as a dot-dash line) to be incident on the atomic object. The first two-photon transition manipulation signal 230 is characterized by a first frequency ω₁ and the second two-photon transition manipulation signal 232 is characterized by a second frequency ω₂. The first two-photon transition manipulation signal 230 is (red) detuned from a transition between the first ground state 212 and the excited state 220 by a single photon detuning Δ_{c}. For example, the sum of the first frequency ω₁ and the single photon detuning Δ_{c} is equal to the frequency difference between the first ground state 212 and the excited state 220.

The first two-photon transition manipulation signal 230 and the second two-photon transition manipulation signal 232 are red detuned from a two-photon transition from the first ground state 212 to the second ground state 214 by a two-photon detuning δ. For example, the sum of the two-photon detuning and the difference between the first frequency ω₁ and the second frequency ω₂ (e.g., (ω₁−ω₂)+δ) is equal to the frequency difference between the first ground state 212 and the second ground state 214.

For an atomic object in the first ground state 212, when the first two-photon transition manipulation signal 230 and the second two-photon transition manipulation signal 232 are incident on the atomic object, the atomic object undergoes a two-photon transition between the first ground state 212 to the second ground state 214 and loses one or more quanta of motional energy (e.g., phonons) having a motional mode frequency substantially similar and/or equal to the two photon detuning δ or an integer fraction of δ (e.g., δ/2, δ/3, etc.). For example, the atomic object undergoes a red detuned sideband transition resulting in the total mechanical energy of the atomic object being reduced (e.g., generally resulting in the temperature of the atomic object being reduced). As used herein, a manipulation signal is red detuned when the manipulation signal is characterized by a frequency that is below the resonant frequency of the corresponding transition.

After the atomic object undergoes the red detuned sideband transition, the atomic object is in the second ground state 214. To repeat the red detuned sideband transition to further reduce the phonon population of a motional mode having a motional mode frequency corresponding to the two-photon detuning δ (e.g., and to therefore reduce the total mechanical energy and/or temperature of the atomic object), the atomic object is repumped back to the first ground state 212 via a repump manipulation signal 240.

The excited state 220 is used as a pathway to repump atomic objects from the second ground state 214 back to the first ground state 212. The repump manipulation signal 240 is configured such that when the repump manipulation signal 240 is incident on an atomic object in the second ground state 214, the atomic object is repumped and/or undergoes a transition to the excited state 220. The atomic object then spontaneously decays from the excited state to the first ground state 212 or the second ground state 214. For example, when the atomic object spontaneously decays from the excited state, there is non-zero probability that the atomic object will decay to the first ground state 212 and a non-zero probability that the atomic object will decay to the second ground state 214. When the atomic object decays from the excited state 220 to the first ground state 212, the first two-photon transition manipulation signal 230 and the second two-photon transition manipulation signal 232 cause the atomic object to undergo another red detuned sideband transition, resulting in further cooling of the atomic object. When the atomic object decays from the excited state 220 to the second ground state 214, the repump manipulation signal 240 repumps the atomic object back to the excited state 220, from which the atomic object may decay to the first ground state 212 or the second ground state 214.

In various embodiments, the repump manipulation signal 240 is red detuned from the transition between the second ground state 214 and the excited state 220 by a repump detuning Δᵣ. The repump detuning Δᵣ is configured to cause Doppler cooling to be performed on the atomic object as a result of the repumping of the atomic object. For example, the first two-photon transition manipulation signal 230, second two-photon transition manipulation signal 232, and repump manipulation signal 240 being incident on the atomic object causes the atomic object to rotate through a cooling cycle including a red detuned sideband transition and one or more red detuned repumps and decays.

Thus, as an atomic object is subjected to an SSD cooling operation, the atomic object undergoes a series of red detuned sideband transitions alternating with a series of Doppler cooling-inducing repump and decays. Thus, an SSD cooling operation causes an atomic object to simultaneously (e.g., via operation under a single set of parameters) undergo sideband cooling and Doppler cooling.

The set of parameters of an SSD cooling operation therefore include the respective intensities of each of the first two-photon transition manipulation signal 230, the second two-photon transition manipulation signal 232, and the repump manipulation signal 240, the repump detuning Δᵣ, the single photon detuning Δ_{c}, and the two-photon detuning δ.

In various embodiments, the parameters of an SSD cooling operation are determined and/or set based on empirical data and/or simulations. For example, the parameters of an SSD cooling operation may be optimized based at least in part on parameter boundaries set based on the application, hardware, and/or the like. In an example embodiment, a first parameter (e.g., the single photon detuning Δ_{c}) is set to a fixed value and the remaining parameters are optimized in light of the fixed value of the first parameter.

In various embodiments, more than one repump manipulation signal may be used and each of the repump manipulation signals may have a respective repump detuning. In an example embodiment, the excited state through which the atomic object is repumped (e.g., by one or more repump manipulation signals) is different from the excited state referenced by the two-photon transition.

In various embodiments, each of the first two-photon transition manipulation signal 230, the second two-photon transition manipulation signal 232, and the repump manipulation signal 240 are provided continuously during performance of the SSD cooling operation.

In various embodiments, the repump detuning Δᵣ is similar to the linewidth Γ of the excited state 220. In various embodiments, the repump detuning Δᵣ is in a range of 0.2 to 10 times the linewidth Γ of the excited state 220.

In various embodiments, the single photon detuning Δ_{c} is selected from one of a near detuned regime and a further detuned regime. In a near detuned regime, the single photon detuning Δ_{c} is in a range of 0.5 to 200 times or 0.5 to 500 times the linewidth Γ of the excited state 220. In the further detuned regime, the single photon detuning Δ_{c} is in a range of 500 to 100,000 (or even larger in some instances) times the linewidth Γ of the excited state 220.

In various embodiments, when the single photon detuning Δ_{c} is selected from the near detuned regime, one or more of the first two-photon transition manipulation signal 230, the second two-photon transition manipulation signal 232, and/or the repump manipulation signal 240 are provided as sheet beams. Sheet beams are beams that are configured to be incident on multiple regions of the confinement apparatus 50 (in contrast to pencil beam or focused beam that is configured to be incident on a particular location and/or only in a particular region of the confinement apparatus 50). In an example embodiment, when the single photon detuning Δ_{c} is selected from the near detuned regime, each of the first two-photon transition manipulation signal 230, the second two-photon transition manipulation signal 232, and the repump manipulation signal 240 are provided as sheet beams. In an example embodiment, when the single photon detuning Δ_{c} is selected from the near detuned regime, one or more of the first two-photon transition manipulation signal 230, the second two-photon transition manipulation signal 232, and/or the repump manipulation signal 240 are provided as pencil beams and/or focused beams.

In various embodiments, when the single photon detuning Δ_{c} is selected from the further detuned regime, the intensities of the first two-photon transition manipulation signal and the second two-photon transition manipulation signal incident on an atomic object to drive the cooling cycle is higher than when the single photon detuning Δ_{c} is selected from the near detuned regime. In various embodiments, when the single photon detuning Δ_{c} is selected from the further detuned regime, one or more of the first two-photon transition manipulation signal 230, second two-photon transition manipulation signal 232, and/or repump manipulation signal 240 is provided as a pencil beam and/or focused beam.

In various embodiments, the set of parameters is configured to provide cooling of multiple motional modes of the atomic object simultaneously. For example, the two-photon transition is broadened such that multiple motional modes can be cooled simultaneously (rather than in series). For example, one or more of the respective intensities of the first two-photon transition manipulation signal 230, the second two-photon transition manipulation signal 232, and the repump manipulation signal 240 and/or the repump detuning Δᵣ are set so as to cause the two-photon transition to be sufficiently broadened such that multiple motional modes can be cooled using a single set of parameters for a cooling operation.

In certain embodiments, the set of parameters is configured to provide cooling of an individual motional mode of the atomic object. For example, the first two-photon transition manipulation signal 230 and the second two-photon transition manipulation signal 232 may be configured to cool a respective motional mode of the atomic object and the repump manipulation signal 240 may be red-detuned (e.g., such that Doppler cooling and RSB cooling may be performed simultaneously). Multiple (e.g., two or more) motional modes of the atomic object may then be cooled in serial with an increased cooling rate such that the overall cooling time is less than a conventional cooling time and, in some embodiments, less than a cooling time required for parallel cooling of multiple motional modes.

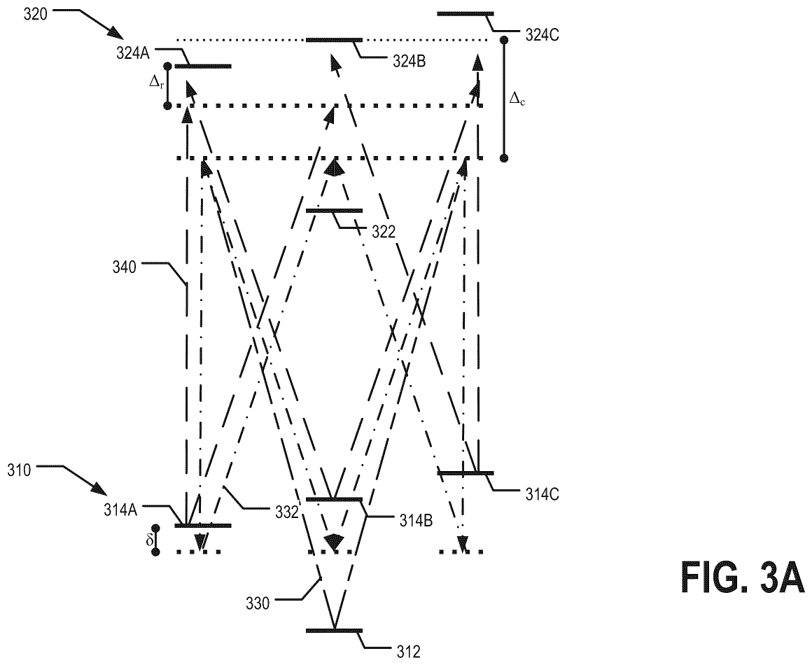

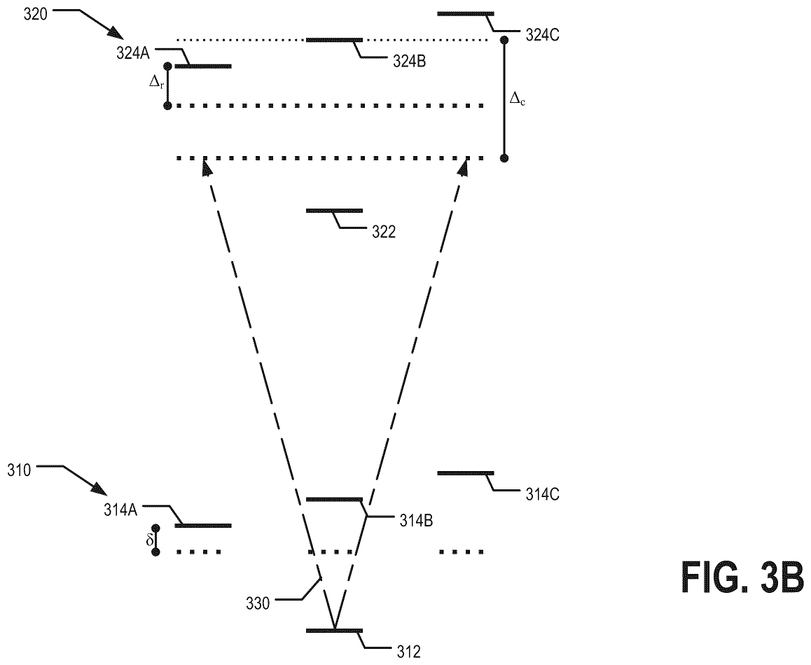

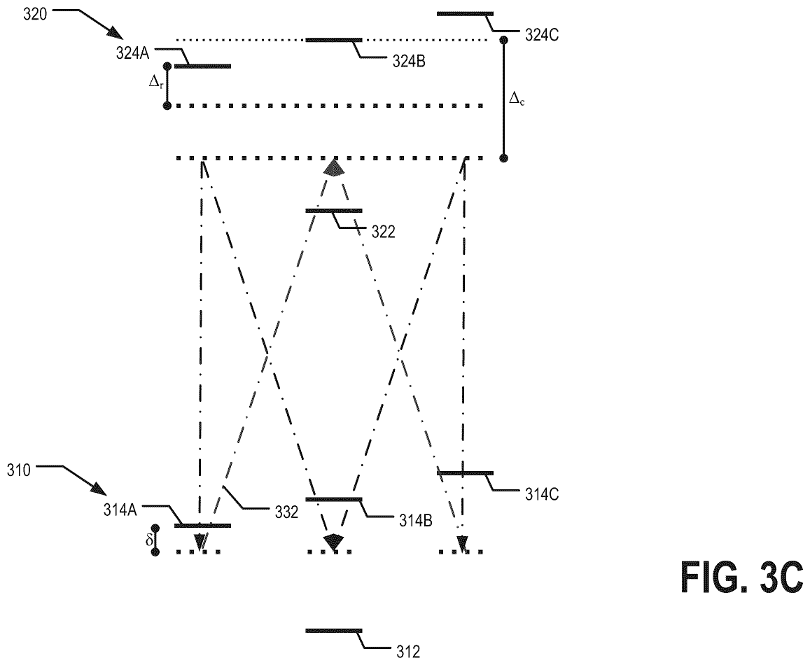

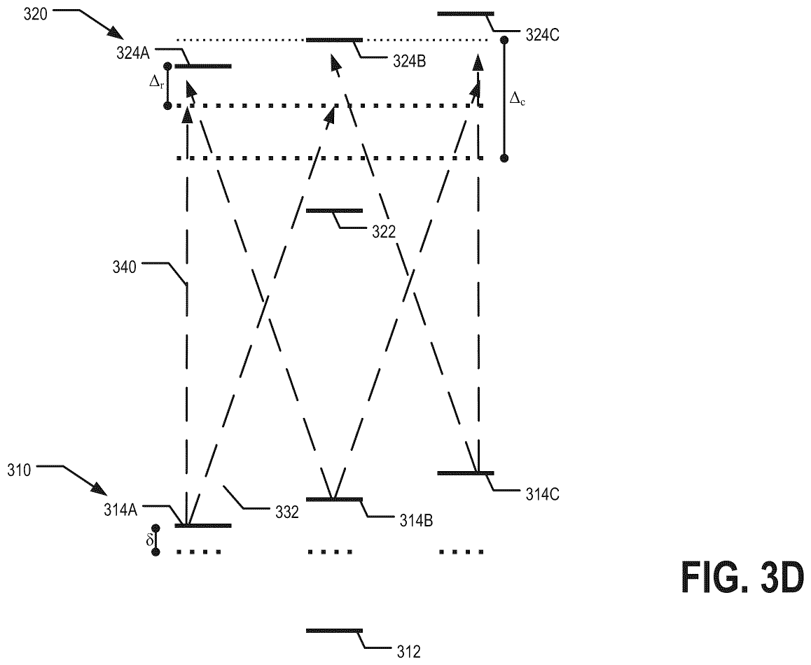

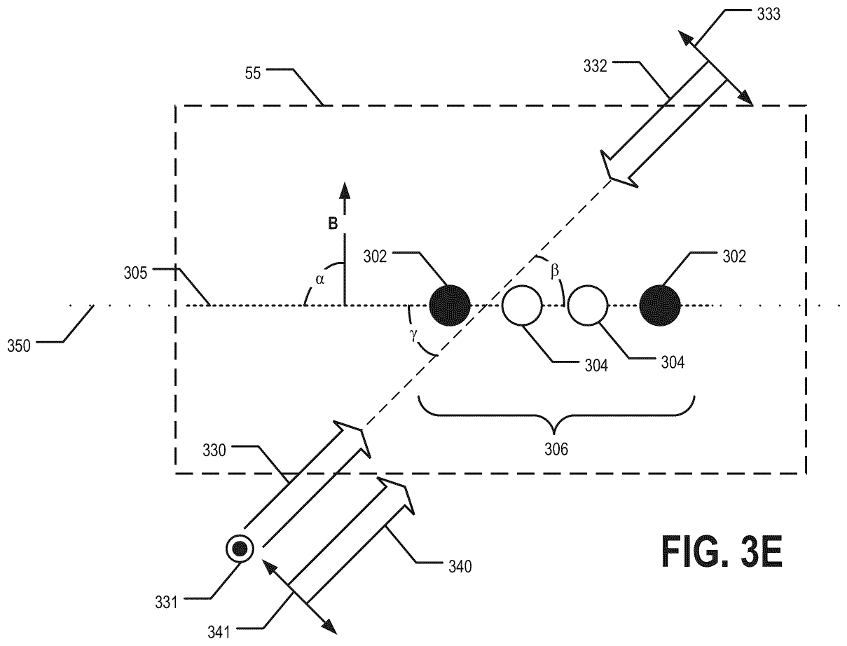

FIGS. 3A, 3B, 3C, 3D, and 3E illustrate an example SSD cooling operation performed on an atomic object that is a singly ionized atom having a half-integer nuclear spin. For example, the level diagram of FIG. 3A illustrates an example energy structure of an atomic object having a half-integer nuclear spin. In particular, FIG. 3A illustrates a system with a nuclear spin I=½. However, as should be understood, the SSD cooling operation may be performed on atomic objects with other half-integer nuclear spins (e.g., I=1½, 2½, and/or the like) in addition to systems with nuclear spin I=½. FIGS. 3B, 3C, and 3D each illustrate a respective manipulation signal shown in FIG. 3A for the sake of clarity. The example energy structure includes a ground manifold 310 and an excited manifold 320.

The ground manifold 310 includes a first ground state 312 and a set of second ground states 314 (e.g., 314A, 314B, 314C). The set of second ground states 314 includes states of the ground manifold 310 that are degenerate when the atomic object is not in the presence of a magnetic field. When the atomic object is in the presence of a magnetic field, the second ground states 314A, 314B, 314C are split via Zeeman splitting. For example, in an example embodiment, the ground manifold 310 is the S_{1/2} manifold, the first ground state 312 is the S_{1/2}, F=0, m=0 state and the second ground states 314 are the S_{1/2}, F=1, m=−1, 0, +1 states.

The excited manifold 320 includes a first excited state 322 and a set of second excited states 324 (e.g., 324A, 324B, 324C). The set of second excited states 324 includes states of the excited manifold 320 that are degenerate when the atomic object is not in the presence of a magnetic field. When the atomic object is in the presence of a magnetic field, the second excited states 324A, 324B, 324C are split via Zeeman splitting. For example, in an example embodiment, the excited manifold 320 is the P_{1/2} manifold, the first excited state 322 is the P_{1/2}, F=0, m=0 state and the second excited states 324 are the P_{1/2}, F=1, m=−1, 0, +1 states.

The first two-photon transition manipulation signal 330 is red detuned from a transition between the first ground state 312 and the middle second excited states 324B by a single photon detuning Δ_{c}. The second two-photon transition manipulation signal 332 is configured to, with the first two-photon transition manipulation signal 330, cause an atomic object in the first ground state 312 to undergo a two-photon transition to a second ground state 314. The first two-photon transition manipulation signal 330 and the second two-photon transition manipulation signal 332 are red detuned from a two-photon transition from the first ground state 312 to the second ground state 314 by a two-photon detuning δ. Thus, when the atomic object undergoes the two-photon transition between the first ground state 312 and a second ground state 314, the atomic object undergoes a red sideband transition. The red sideband transition results in the total mechanical energy of a particular mode of the atomic object and/or object crystal being reduced.

As shown in FIG. 3A, red detuned sideband transitions from the first ground state 312 to each of the second ground states 314A, 314B, 314C are allowed with different two-photon detunings 6 for each transition. Once the two-photon detuning δ is set for the red detuned sideband transition from the first ground state 312 to the second ground state 314A, the two-photon detunings for the red detuned sideband transitions from the first ground state 312 to the second ground states 314B, 314C are determined by the Zeeman splitting (e.g., the structure of the atomic object and the magnetic field magnitude experienced by the atomic object). The various two-photon detunings 6 of the various red detuned sideband transitions provides a configuration in which the Raman sideband cooling is performed on multiple sidebands simultaneously, which can enhance cooling performance for multiple modes and/or at higher temperatures. In an example embodiment, when particular sideband transitions are desired, they are selected through selection of the respective polarizations of the first two-photon transition manipulation signal 330 and the second two-photon transition manipulation signal 332.

A repump manipulation signal 340 is detuned from a transition between a second ground state 314 and a second excited state 324 by a repump detuning Δᵣ. The repump manipulation signal 340 is configured to use the second excited state 324 as a pathway to return the atomic object to the first ground state 312 from the second ground state 314. The repump detuning Δᵣ is configured to cause Doppler cooling to be performed on the atomic object as a result of the repumping of the atomic object. For example, the first two-photon transition manipulation signal 330, second two-photon transition manipulation signal 332, and repump manipulation signal 340 being incident on the atomic object causes the atomic object to rotate through a cooling cycle including a red detuned sideband transition and one or more red detuned repumps and decays.

Thus, as an atomic object is subjected to an SSD cooling operation, the atomic object undergoes a series of red detuned sideband transitions alternating with a series of Doppler cooling-inducing repump and decays. Thus, an SSD cooling operation causes an atomic object to simultaneously (e.g., via operation under a single set of parameters) undergo sideband cooling and Doppler cooling.

In various embodiments, the repump detuning Δᵣ is similar to the linewidth Γ of the second excited state 324. In various embodiments, the repump detuning Δᵣ is in a range of 0.2 to 10 times the linewidth Γ of the second excited state 324.

In various embodiments, the single photon detuning Δ_{c} is selected from one of a near detuned regime and a further detuned regime. In a near detuned regime, the single photon detuning Δ_{c} is in a range of 0.5 to 200 times or 0.5 to 500 times the linewidth Γ of the second excited state 324. In the further detuned regime, the single photon detuning Δ_{c} is in a range of 500 to 100,000 times the linewidth Γ of the second excited state 324.

In various embodiments, when the single photon detuning Δ_{c} is selected from the near detuned regime, one or more of the first two-photon transition manipulation signal 330, the second two-photon transition manipulation signal 332, and/or the repump manipulation signal 340 are provided as sheet beams. In an example embodiment, when the single photon detuning Δ_{c} is selected from the near detuned regime, each of the first two-photon transition manipulation signal 330, the second two-photon transition manipulation signal 332, and the repump manipulation signal 340 are provided as sheet beams. In an example embodiment, when the single photon detuning Δ_{c} is selected from the near detuned regime, one or more of the first two-photon transition manipulation signal 330, the second two-photon transition manipulation signal 332, and/or the repump manipulation signal 340 are provided as pencil beams and/or focused beams.

In various embodiments, when the single photon detuning Δ_{c} is selected from the further detuned regime, one or more of the first two-photon transition manipulation signal 330, second two-photon transition manipulation signal 332, and/or repump manipulation signal 340 is provided as a pencil beam and/or focused beam.

In various embodiments, the set of parameters of the cooling operation is configured to provide cooling of multiple motional modes of the atomic object simultaneously. For example, the two-photon transition is broadened such that multiple motional modes can be cooled simultaneously (rather than in series). For example, one or more of the respective intensities of the first two-photon transition manipulation signal 330, the second two-photon transition manipulation signal 332, and the repump manipulation signal 340 and/or the repump detuning Δᵣare set so as to cause the two-photon transition to be sufficiently broadened such that multiple motional modes can be cooled using a single set of parameters for a cooling operation.

FIG. 3E illustrates an example geometry that may be used to perform the SSD cooling illustrated in FIG. 3A. FIG. 3E shows an object crystal 306 located and/or disposed in particular region 55 of the confinement apparatus 50. The object crystal 306 comprises two atomic objects 302 and two qubit objects 304. The atomic objects 302 and the qubit objects 304 of the object crystal 306 are aligned along and/or disposed so as to define a crystal axis 305. In an example embodiment, the crystal axis 305 is substantially parallel to a radio frequency null 350 of the particular region 55 of the confinement apparatus 50. The radio frequency null 350 is the zero-point line of a pseudopotential generated by applying a radio frequency voltage signal to radio frequency electrodes and/or rails of the confinement apparatus 50.

In various embodiments, a magnetic field B is generated such that in the particular region 55 the magnetic field B has a finite and substantially stable (e.g., not changing with time) amplitude (e.g., 0.5-10 Gauss and/or 5 Gauss in an example embodiment). In various embodiments, the magnetic field B in the particular region 55 has a magnetic field direction that forms an angle α with the crystal axis 305. In an example embodiment, the angle α is greater than 0 and less than 180 degrees. In an example embodiment, the angle α is approximately 90 degrees. In various embodiments, the magnetic field direction is not parallel to the crystal axis 305.

In various embodiments, the first two-photon transition manipulation signal 330 has a polarization 331. In an example embodiment, the polarization 331 of the first two-photon transition manipulation signal 330 is a linear polarization that is out of the plane defined by the magnetic field direction and the crystal axis 305. For example, the polarization of the first two-photon transition manipulation signal 330 and the magnetic field direction is 90 degrees, in the illustrated embodiment. In various embodiments, the first two-photon transition manipulation signal 330 propagates in a first propagation direction. In various embodiments, the first propagation direction is transverse to the crystal axis 305. In an example embodiment, the first two-photon transition manipulation signal 330 propagates in a first propagation direction that forms an angle γ with the crystal axis 305. In various embodiments, the angle γ may be any angle. In various embodiments, the angle γ is configured such that the first propagation direction of the first two-photon transition manipulation signal 330 is not parallel or anti-parallel to the crystal axis 305. In various embodiments, the angle γ is in a range of 0 to 90 degrees. In an example embodiment, the angle γ is approximately 45 degrees.

In various embodiments, the second two-photon transition manipulation signal 332 has a polarization 333. In an example embodiment, the polarization 333 of the second two-photon transition manipulation signal 332 is a linear polarization that is in the plane defined by the magnetic field direction and the crystal axis 305. In various embodiments, polarization 333 of the second two-photon transition manipulation signal 332 can be any angle with respect to the magnetic field direction. In an example embodiment, the polarization 333 of the second two-photon transition manipulation signal 332 is transverse to the magnetic field direction. In various embodiments, the second two-photon transition manipulation signal 332 propagates in a second propagation direction. In various embodiments, the second propagation direction is transverse to the crystal axis 305. In an example embodiment, the second two-photon transition manipulation signal 332 propagates in a second propagation direction that forms an angle β with the crystal axis 305. In various embodiments, the angle β is in a range of 0 to 90 degrees. In an example embodiment, the angle β is approximately 45 degrees.

In various embodiments, the first propagation direction is substantially anti-parallel to the second propagation direction. In various embodiments, both the first propagation direction and the second propagation are transverse to the magnetic field direction.

In various embodiments, the repump manipulation signal 340 propagates in the first propagation direction or in the second propagation direction. The illustrated embodiment shows the repump manipulation signal 340 propagating in the first propagation direction. In the illustrated embodiment, the repump manipulation signal 340 has a polarization 341 that is a linear polarization in the plane defined by the magnetic field direction and the crystal axis 305. In an example embodiment, the repump manipulation signal 340 has a polarization that is into or out of the plane defined by the magnetic field direction and the crystal axis 305.

An example atomic object having a half integer nuclear spin is singly ionized ¹⁷¹Yb. An example of a set of parameters for cooling singly ionized ¹⁷¹Yb with SSD cooling where the magnetic field amplitude is 2.3 G includes a first two-photon transition manipulation signal 330 intensity of 14.4 mW/mm², a second two-photon transition manipulation signal 332 intensity of 14.4 mW/mm², a repump manipulation signal 340 intensity 0.53 mW/mm², a two photon detuning δ=2π·1.95 MHz, a single photon detuning Δ_{c}=2π·400 MHz (e.g., ˜20Γ), and a repump detuning Δᵣ=2π·10 MHz (e.g., ˜Γ/2). Some other examples of atomic objects having half integer nuclear spins include singly ionized ⁸⁷Sr, singly ionized ¹³⁷Ba, and singly ionized ³⁹Ca.

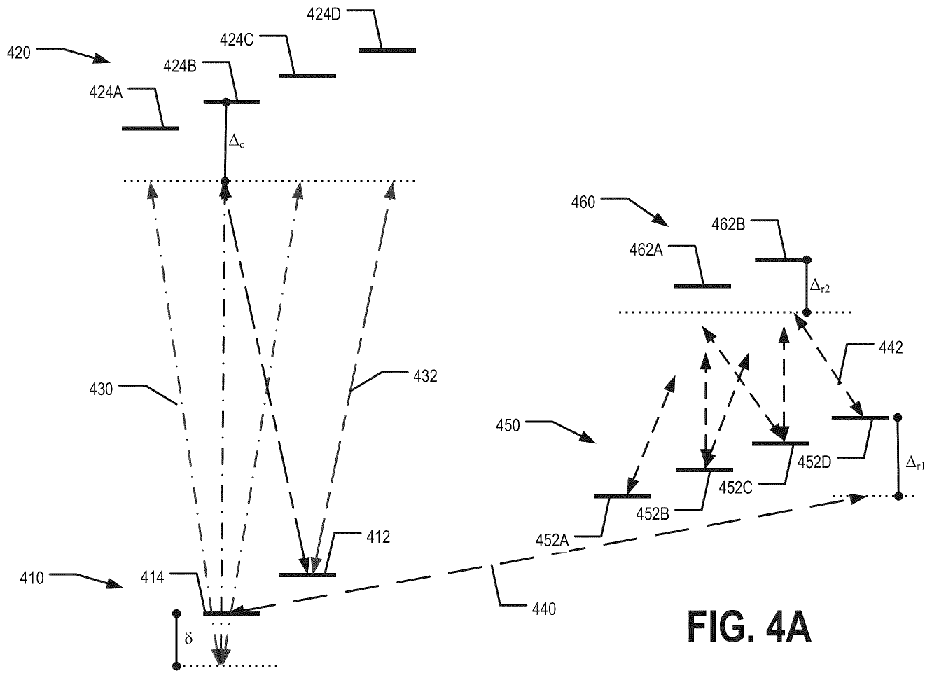

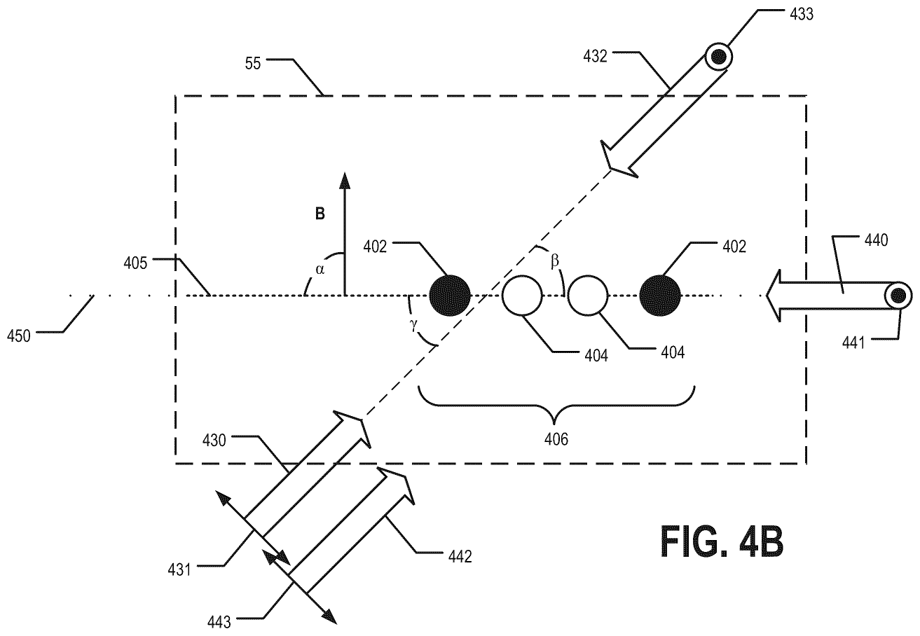

FIGS. 4A and 4B illustrate an example SSD cooling operation performed on an atomic object that is a singly ionized atom having nuclear spin zero without the use of manipulation signals having circular polarization. For example, FIGS. 4A and 4B illustrate an example SSD cooling operation performed on an atomic object having nuclear spin zero using only linearly polarized manipulation signals. An example of an atomic object having nuclear spin zero include singly ionized ⁸⁸Sr, singly ionized ¹³⁸Ba, and singly ionized ⁴⁰ Ca. For example, the level diagram of FIG. 4A illustrates an example energy structure of an atomic object having nuclear spin zero. The example energy structure includes a ground manifold 410 and an excited manifold 420.

In the example embodiments illustrated in FIGS. 2, 3A, and 5A, the excited state/manifold 220, 320, 520 is also a repump manifold. In the example embodiment illustrated in FIG. 4A, the excited manifold 420 is not used as a repump manifold. Rather, dedicated repump manifolds are used to provide a pathway from a second ground state 414 to the first ground state 412. For example, the example energy structure illustrated in FIG. 4A includes a first repump manifold 450 and a second repump manifold 460.

The ground manifold 410 includes a first ground state 412 and a second ground state 414. For example, in an example embodiment, the ground manifold 410 is the S_{1/2} manifold, the first ground state 412 is the S_{1/2}, M=−1/2 state and the second ground state 414 is the S_{1/2}, M=1/2 state.

The excited manifold 420 includes a set of excited states 424 (e.g., 424A, 424B, 424C, 424D). For example, in an example embodiment, the excited manifold 420 is the P_{3/2} manifold, and the excited states 424 are the P_{3/2}, M=−3/2, −1/2, −1/2, 3/2 states.

In the illustrated embodiment, the first repump manifold 450 includes a set of first repump states 452 (e.g., 452A, 452B, 452C, 452D). In an example embodiment, the first repump manifold 450 is the D_{3/2} manifold and the first repump states 452 are the D_{3/2}, M=−3/2, −1/2, 1/2, 3/2 states.

In the illustrated embodiment, the second repump manifold 460 includes a set of second repump states 462 (e.g., 462A, 462B). In an example embodiment, the second repump manifold 460 is the P_{1/2} manifold and the second repump states 462 are the P_{1/2}, M=−1/2, 1/2 states.

The first two-photon transition manipulation signal 430 is red detuned from a transition between the first ground state 412 and a middle one of the excited states 424 (e.g., 424B) by a single photon detuning Δ_{c}. The second two-photon transition manipulation signal 432 is configured to, with the first two-photon transition manipulation signal 430, cause an atomic object in the first ground state 412 to undergo a two-photon transition to the second ground state 414. The first two-photon transition manipulation signal 430 and the second two-photon transition manipulation signal 432 are red detuned from a two-photon transition from the first ground state 412 to the second ground state 414 by a two-photon detuning δ. Thus, when the atomic object undergoes the two-photon transition between the first ground state 412 and the second ground state 414, the atomic object undergoes a red sideband transition. The red sideband transition results in the total mechanical energy of the atomic object being reduced.

A first repump manipulation signal 440 is either on resonance or is red detuned from a transition between a second ground state 414 and a first repump state 452 by a first repump detuning Δᵣ₁. A second repump manipulation signal 442 is red detuned from a transition between a first repump state 452 to a second repump state 462 by a second repump detuning Δᵣ₂.

The first repump manipulation signal 440 and the second repump manipulation signal 442 are collectively configured to use the first repump states 452 and the second repump states 462 as a pathway to return the atomic object to the first ground state 412 from the second ground state 414. The first repump detuning Δᵣ₁ and the second repump detuning Δᵣ₂ are configured to cause additional sideband and/or Doppler cooling to be performed on the atomic object as a result of the repumping of the atomic object.

In an example embodiment, the first repump detuning Δᵣ₁ is zero, while the second repump detuning Δᵣ₁ is nonzero, causing Doppler cooling to occur on the second repump transition. For example, in an example embodiment, the first repump manipulation signal 440 is on resonance with the first repump transition.

In an example embodiment, the linewidth of the first repump state 452 is large compared to the spread of motional frequencies of the motional modes of the atomic object, due to the intensity of the second repump manipulation signal 442, and both the first repump detuning Δᵣ₁ and the second repump detuning Δᵣ₁ are nonzero, causing Doppler cooling on both repump transitions.

In an example embodiment, the linewidth of the first repump state 452 is on the order of, or smaller than, the spread in motional frequencies of the motional modes of the atomic object, and first repump detuning Δᵣ₁ is configured to cause sideband cooling, while the second repump detuning Δᵣ₂ is configured to cause Doppler cooling.

Thus, the first two-photon transition manipulation signal 430, second two-photon transition manipulation signal 432, first repump manipulation signal 440, and second repump manipulation signal 442 being incident on the atomic object causes the atomic object to rotate through a cooling cycle including one or more red detuned sideband transitions and one or more red detuned repumps and decays.

Thus, as an atomic object is subjected to an SSD cooling operation, the atomic object undergoes a series of red detuned sideband transitions alternating with a series of Doppler cooling-inducing repump and decays. Thus, an SSD cooling operation causes an atomic object to simultaneously (e.g., via operation under a single set of parameters) undergo sideband cooling and Doppler cooling.

In various embodiments, the first repump detuning Δᵣ₁ is similar to the linewidth of a first repump state 452 and the second repump detuning Δᵣ₂ is similar to the linewidth of the second repump state 462. In various embodiments, the first repump detuning Δᵣ₁ is in a range of 0.2 to 10 times the linewidth of the first repump state 452 and the second repump detuning Δᵣ₂ is in a range of 0.2 to 10 times the linewidth of the second repump state 462. In various embodiments, when the linewidth of the first repump state 452 is narrow and the linewidth of the second repump state 462 is broad, the first repump detuning Δᵣ₁ is tuned to be near a red motional sideband to cause resolved sideband cooling on the first repump transition, while the second repump detuning Δᵣ₂ is in a range of 0.2 to 10 times the linewidth of the second repump state 462.

In various embodiments, the single photon detuning Δ_{c} is selected from one of a near detuned regime and a further detuned regime. In a near detuned regime, the single photon detuning Δ_{c} is in a range of 0.5 to 200 times or 0.5 to 500 times the linewidth Γ of the excited state 424. In the further detuned regime, the single photon detuning Δ_{c} is in a range of 500 to 100,000 times the linewidth Γ of the excited state 424.

In various embodiments, when the single photon detuning Δ_{c} is selected from the near detuned regime, one or more of the first two-photon transition manipulation signal 430, the second two-photon transition manipulation signal 432, the first repump manipulation signal 440, and/or the second repump manipulation signal 442 are provided as sheet beams. In an example embodiment, when the single photon detuning Δ_{c} is selected from the near detuned regime, each of the first two-photon transition manipulation signal 430, the second two-photon transition manipulation signal 432, the first repump manipulation signal 440, the second repump manipulation signal 442 are provided as sheet beams. In an example embodiment, when the single photon detuning Δ_{c} is selected from the near detuned regime, one or more of the first two-photon transition manipulation signal 430, the second two-photon transition manipulation signal 432, the first repump manipulation signal 440, and/or the second repump manipulation signal 442 are provided as pencil beams and/or focused beams.

In various embodiments, when the single photon detuning Δ_{c} is selected from the further detuned regime, one or more of the first two-photon transition manipulation signal 430, second two-photon transition manipulation signal 432, first repump manipulation signal 440, and/or second repump manipulation signal 442 is provided as a pencil beam and/or focused beam.

In various embodiments, the set of parameters of the cooling operation is configured to provide cooling of multiple motional modes of the atomic object simultaneously. For example, the two-photon transition is broadened such that multiple motional modes can be cooled simultaneously (rather than in series). For example, one or more of the respective intensities of the first two-photon transition manipulation signal 430, the second two-photon transition manipulation signal 432, the first repump manipulation signal 440, and the second repump manipulation signal 442 and/or the first repump detuning Δᵣ₁ and second repump detuning Δᵣ₂ are set so as to cause the two-photon transition to be sufficiently broadened such that multiple motional modes can be cooled using a single set of parameters for a cooling operation.

FIG. 4B illustrates an example geometry that may be used to perform the SSD cooling illustrated in FIG. 4A. FIG. 4B shows an object crystal 406 located and/or disposed in particular region 55 of the confinement apparatus 50. The object crystal 406 comprises two atomic objects 402 and two qubit objects 404. The atomic objects 402 and the qubit objects 404 of the object crystal 406 are aligned along and/or disposed so as to define a crystal axis 405. In an example embodiment, the crystal axis 405 is substantially parallel to a radio frequency null 450 of the particular region 55 of the confinement apparatus 50.

In various embodiments, a magnetic field B is generated such that in the particular region 55 the magnetic field B has a finite and substantially stable (e.g., not changing with time) amplitude (e.g., 0.5-10 Gauss and/or 5 Gauss in an example embodiment). In various embodiments, the magnetic field B in the particular region 55 has a magnetic field direction that forms an angle α with the crystal axis 305. In an example embodiment, the angle α is approximately 90 degrees. In various embodiments, the magnetic field direction is parallel to the crystal axis 305 (e.g., α=0 degrees). In various embodiments, the magnetic field direction is neither nor anti-parallel to the crystal axis 305 (e.g., α=45 degrees).

In various embodiments, the first two-photon transition manipulation signal 430 has a polarization 431. In an example embodiment, the polarization 431 of the first two-photon transition manipulation signal 430 is a linear polarization that is in the plane defined by the magnetic field direction and the crystal axis 405. In various embodiments, the first two-photon transition manipulation signal 430 propagates in a first propagation direction. In various embodiments, the first propagation direction is transverse to the crystal axis 405. In an example embodiment, the first two-photon transition manipulation signal 430 propagates in a first propagation direction that forms an angle γ with the crystal axis 405. In various embodiments, the angle γ is configured such that the first propagation direction of the first two-photon transition manipulation signal 430 is not parallel or anti-parallel to the magnetic field direction. In various embodiments, the angle γ is configured such that the first propagation direction of the first two-photon transition manipulation signal 430 is not parallel or anti-parallel to the crystal axis 305. In various embodiments, the angle γ is in a range of 0 to 90 degrees. In an example embodiment, the angle γ is approximately 45 degrees.

In various embodiments, the second two-photon transition manipulation signal 432 has a polarization 433. In an example embodiment, the polarization 433 of the second two-photon transition manipulation signal 432 is a linear polarization that is out of the plane defined by the magnetic field direction and the crystal axis 405. In an example embodiment, the polarization 433 of the second two-photon transition manipulation signal 432 is transverse to the magnetic field direction. In various embodiments, the second two-photon transition manipulation signal 432 propagates in a second propagation direction. In various embodiments, the second propagation direction is transverse to the crystal axis 405. In an example embodiment, the second two-photon transition manipulation signal 432 propagates in a second propagation direction that forms an angle β with the crystal axis 405. In various embodiments, the angle β is in a range of 0 to 90 degrees. In an example embodiment, the angle β is approximately 45 degrees.

In various embodiments, the first propagation direction is substantially anti-parallel to the second propagation direction. In various embodiments, both the first propagation direction and the second propagation are transverse to the magnetic field direction.

In various embodiments, the first repump manipulation signal 440 propagates in a direction that is aligned with and/or parallel to the crystal axis 405. The first repump manipulation signal 440 has a polarization 441 that is a linear polarization out of the plane defined by the magnetic field direction and the crystal axis 405.

In various embodiments, the second repump manipulation signal 442 propagates in the first propagation direction or in the second propagation directed. The illustrated embodiment shows the second repump manipulation signal 442 propagating in the first propagation direction. The second repump manipulation signal 442 has a polarization 443 that is a linear polarization in the plane defined by the magnetic field direction and the crystal axis 405.

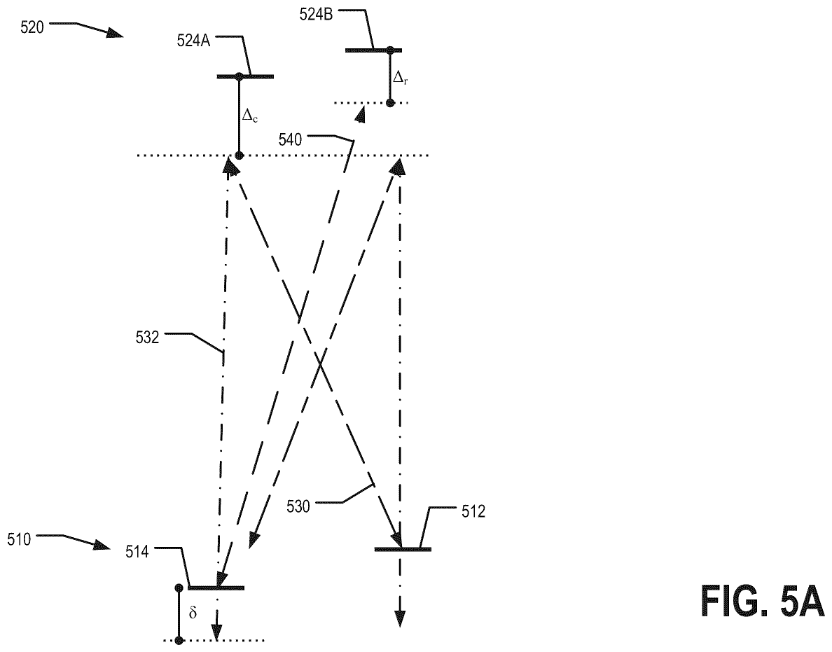

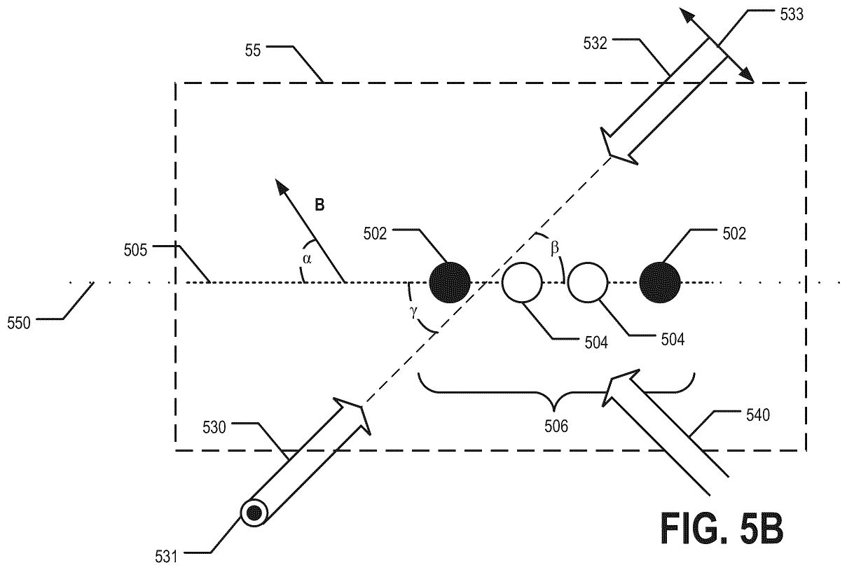

FIGS. 5A and 5B illustrate an example SSD cooling operation performed on an atomic object that is a singly ionized atom having nuclear spin zero using at least one manipulation signal having circular polarization. An example of an atomic object having nuclear spin zero include singly ionized ⁸⁸Sr, singly ionized ¹³⁸Ba, and singly ionized ⁴⁰Ca. For example, the level diagram of FIG. 5A illustrates an example energy structure of an atomic object having a nuclear spin zero. The example energy structure includes a ground manifold 510 and an excited manifold 520.

The ground manifold 510 includes a first ground state 512 and a second ground state 514. For example, in an example embodiment, the ground manifold 510 is the S_{1/2} manifold, the first ground state 512 is the S_{1/2}, M=−1/2 state and the second ground state 514 is the S_{1/2}, M=+1/2 state.

The excited manifold 520 includes a set excited states 524 (e.g., 524A, 524B). For example, in an example embodiment, the excited manifold 520 is the P_{1/2} manifold, and the excited states 524 are the P_{1/2}, M=−1/2, 1/2 states.

The first two-photon transition manipulation signal 530 is red detuned from a transition between the first ground state 512 and a second excited state 524A by a single photon detuning Δ_{c}. The second two-photon transition manipulation signal 532 is configured to, with the first two-photon transition manipulation signal 530, cause an atomic object in the first ground state 512 to undergo a two-photon transition to a second ground state 514. The first two-photon transition manipulation signal 530 and the second two-photon transition manipulation signal 532 are red detuned from a two-photon transition from the first ground state 512 to the second ground state 514 by a two-photon detuning δ. Thus, when the atomic object undergoes the two-photon transition between the first ground state 512 and the second ground state 514, the atomic object undergoes a red sideband transition. The red sideband transition results in the total mechanical energy of the atomic object being reduced.

A repump manipulation signal 540 is detuned from a transition between a second ground state 514 and a second excited state 524 (e.g., second excited state 524B) by a repump detuning Δᵣ. The repump manipulation signal 440 is configured to use the second excited state 524 (e.g., second excited state 524B) as a pathway to return the atomic object to the first ground state 512 from the second ground state 514. The repump detuning Δᵣ is configured to cause Doppler cooling to be performed on the atomic object as a result of the repumping of the atomic object. For example, the first two-photon transition manipulation signal 530, second two-photon transition manipulation signal 532, and repump manipulation signal 540 being incident on the atomic object causes the atomic object to rotate through a cooling cycle including a red detuned sideband transition and one or more red detuned repumps and decays.

Thus, as an atomic object is subjected to an SSD cooling operation, the atomic object undergoes a series of red detuned sideband transitions alternating with a series of Doppler cooling-inducing repump and decays. Thus, an SSD cooling operation causes an atomic object to simultaneously (e.g., via operation under a single set of parameters) undergo sideband cooling and Doppler cooling.

In various embodiments, the repump detuning Δᵣ is similar to the linewidth Γ of the second excited state 524. In various embodiments, the repump detuning Δᵣ is in a range of 0.2 to 10 times the linewidth Γ of the second excited state 524.

In various embodiments, the single photon detuning Δ_{c} is selected from one of a near detuned regime and a further detuned regime. In a near detuned regime, the single photon detuning Δ_{c} is in a range of 0.5 to 200 times or 0.5 to 500 times the linewidth Γ of the second excited state 524. In the further detuned regime, the single photon detuning Δ_{c} is in a range of 500 to 100,000 times the linewidth Γ of the second excited state 524.

In various embodiments, when the single photon detuning Δ_{c} is selected from the near detuned regime, one or more of the first two-photon transition manipulation signal 530, the second two-photon transition manipulation signal 532, and/or the repump manipulation signal 540 are provided as sheet beams. In an example embodiment, when the single photon detuning Δ_{c} is selected from the near detuned regime, each of the first two-photon transition manipulation signal 530, the second two-photon transition manipulation signal 532, and the repump manipulation signal 540 are provided as sheet beams. In an example embodiment, when the single photon detuning Δ_{c} is selected from the near detuned regime, one or more of the first two-photon transition manipulation signal 530, the second two-photon transition manipulation signal 532, and/or the repump manipulation signal 540 are provided as pencil beams and/or focused beams.

In various embodiments, when the single photon detuning Δ_{c} is selected from the further detuned regime, one or more of the first two-photon transition manipulation signal 530, second two-photon transition manipulation signal 532, and/or repump manipulation signal 540 is provided as a pencil beam and/or focused beam.

In various embodiments, the set of parameters of the cooling operation is configured to provide cooling of multiple motional modes of the atomic object simultaneously. For example, the two-photon transition is broadened such that multiple motional modes can be cooled simultaneously (rather than in series). For example, one or more of the respective intensities of the first two-photon transition manipulation signal 530, the second two-photon transition manipulation signal 532, and the repump manipulation signal 540 and/or the repump detuning Δᵣare set so as to cause the two-photon transition to be sufficiently broadened such that multiple motional modes can be cooled using a single set of parameters for a cooling operation.

FIG. 5B illustrates an example geometry that may be used to perform the SSD cooling illustrated in FIG. 5A. FIG. 5B shows an object crystal 506 located and/or disposed in particular region 55 of the confinement apparatus 50. The object crystal 506 comprises two atomic objects 502 and two qubit objects 504. The atomic objects 502 and the qubit objects 504 of the object crystal 506 are aligned along and/or disposed so as to define a crystal axis 505. In an example embodiment, the crystal axis 505 is substantially parallel to a radio frequency null 550 of the particular region 55 of the confinement apparatus 50. The radio frequency null 550 is the zero-point line of a pseudopotential generated by applying a radio frequency voltage signal to radio frequency electrodes and/or rails of the confinement apparatus 50.

In various embodiments, a magnetic field B is generated such that in the particular region 55 the magnetic field B has a finite and substantially stable (e.g., not changing with time) amplitude (e.g., 0.5-10 Gauss and/or 5 Gauss in an example embodiment). In various embodiments, the magnetic field B in the particular region 55 has a magnetic field direction that forms an angle α with the crystal axis 305. In an example embodiment, the angle α is greater than 0 and less than 180 degrees. In an example embodiment, the angle α is in a range of 30 to 60 degrees. In the illustrated example embodiment, the angle α is approximately 45 degrees.

In various embodiments, the first two-photon transition manipulation signal 530 has a polarization 531. In an example embodiment, the polarization 531 of the first two-photon transition manipulation signal 530 is a linear polarization that is out of the plane defined by the magnetic field direction and the crystal axis 505. For example, in the illustrated embodiment, the polarization 531 of the first two-photon transition manipulation signal 530 is perpendicular to the magnetic field direction. In various embodiments, the first two-photon transition manipulation signal 530 propagates in a first propagation direction. In various embodiments, the first propagation direction is transverse to the crystal axis 505. In an example embodiment, the first two-photon transition manipulation signal 530 propagates in a first propagation direction that forms an angle γ with the crystal axis 305. In various embodiments, the angle γ is configured such that the first propagation direction of the first two-photon transition manipulation signal 530 is not parallel or anti-parallel to the crystal axis 505. In various embodiments, the angle γ is in a range of 0 to 90 degrees. In an example embodiment, the angle γ is approximately 45 degrees.

In various embodiments, the second two-photon transition manipulation signal 532 has a polarization 533. In an example embodiment, the polarization 533 of the second two-photon transition manipulation signal 532 is a linear polarization that is in the plane defined by the magnetic field direction and the crystal axis 305. In an example embodiment, the polarization 533 of the second two-photon transition manipulation signal 532 is transverse (e.g., not parallel) to the magnetic field direction. In the illustrated embodiment, the polarization 533 of the second two-photon transition manipulation signal 532 has a non-zero component parallel to the magnetic field direction. In various embodiments, the second two-photon transition manipulation signal 532 propagates in a second propagation direction. In various embodiments, the second propagation direction is transverse to the crystal axis 505. In an example embodiment, the second two-photon transition manipulation signal 532 propagates in a second propagation direction that forms an angle β with the crystal axis 505. In various embodiments, the angle β is in a range of 0 to 90 degrees. In an example embodiment, the angle β is approximately 45 degrees.

In various embodiments, the first propagation direction is substantially anti-parallel to the second propagation direction.

In various embodiments, the repump manipulation signal 540 propagates in a third propagation direction that is transverse to both the first propagation direction and the second propagation directed. The illustrated embodiment shows the repump manipulation signal 540 propagating in a third propagation direction that is substantially parallel to the magnetic field direction. The repump manipulation signal 540 has a polarization 541 that is a circular polarization.

In various embodiments, the difference between the first propagation direction [symbol] (a unit vector in the direction of the wavevector of a respective first two-photon transition manipulation signal 230, 330, 430, 530) and the second propagation direction [symbol] (a unit vector in the direction of the wavevector of a respective second two-photon transition manipulation signal 232, 332, 432, 532) has a non-zero projection on the direction of the motional mode to be cooled via a red sideband transition component of an SSD cooling component. For example, when the mode of the object crystal 306, 406, 506 to be cooled is an axial mode (e.g., corresponds to motion along the crystal axis 305, 405, 505), î· [symbol] ≠0, where i is a unit vector along the crystal axis 305, 405, 505 and [symbol] = [symbol] − [symbol] . In another example, when the mode of the object crystal 306, 406, 506 to be cooled is a radial mode (e.g., corresponds to motion orthogonal to the crystal axis 305, 405, 505), ĵ− [symbol] ≠0, where ĵ is a radial unit vector (e.g., î·ĵ=0) and [symbol] = [symbol] − [symbol] .

In various embodiments, a repump propagation direction k₃ (a unit vector in the direction of the wavevector of a respective repump manipulation signal 240, 340, 440, 540) has a non-zero projection on the direction of the motional to be cooled via a Doppler cooling component of an SSD cooling operation. For example, when the motional mode of the object crystal 306, 406, 506 to be cooled is an axial mode (e.g., corresponds to motion along the crystal axis 305, 405, 505), î− [symbol] ≠0, where i is a unit vector along the crystal axis 305, 405, 505. In another example, when the motional mode of the object crystal 306, 406, 506 to be cooled is a radial mode (e.g., corresponds to motion orthogonal to the crystal axis 305, 405, 505), ĵ· [symbol] ≠0, where ĵ is a radial unit vector (e.g., î·ĵ=0).

FIGS. 3E, 4B, and 5B illustrate example embodiments where the first two-photon transition manipulation signal, second two-photon transition manipulation signal, repump manipulation signal, and the magnetic field direction are in a common plane (e.g., a plane that is parallel to a surface of the confinement apparatus 50). However, in various embodiments, one or more of the first two-photon transition manipulation signal, second two-photon transition manipulation signal, repump manipulation signal, or the magnetic field direction are transverse to a plane that is parallel to a surface of the confinement apparatus 50. For example, in various embodiments, one or more of the first two-photon transition manipulation signal, second two-photon transition manipulation signal, repump manipulation signal, or the magnetic field direction form respective angles in a range of 10 to 170 degrees with a plane that is parallel to a surface of the confinement apparatus 50. For example, in various embodiments, one or more of the first two-photon transition manipulation signal, second two-photon transition manipulation signal, repump manipulation signal, or the magnetic field direction form respective angles of approximately 45 degrees (e.g., 35 to 55 degrees) with a plane that is parallel to a surface of the confinement apparatus 50.

In various embodiments, as illustrated in FIGS. 2, 3A, 4A, and 5A, the one or more repump manipulation signals are red detuned from a respective transition (e.g., a transition from a second ground state to an excited state, a transition from a first repump state to a second repump state, and/or the like). However, in various embodiments, a repump manipulation signal is on resonance with the respective transition. For example, in an example embodiment, the repump manipulation signal 240 is characterized by a frequency that corresponds to the energy difference between the second ground state 214 the excited state 220. In another example corresponding to FIG. 4A, in an example embodiment, one of the first repump manipulation signal 440 or the second repump manipulation signal 442 is red detuned from a respective transition and the other of the first repump manipulation signal 440 or the second repump manipulation signal 442 is on resonance with a respective transition. In another example corresponding to FIG. 4A, in various embodiments, both of the first repump manipulation signal 440 and the second repump manipulation signal 442 are either red detuned from respective transitions or both the first repump manipulation signal 440 and the second repump manipulation signal 442 are on resonance with respective transitions.

### Example Method of Performing an SSD Cooling Operation

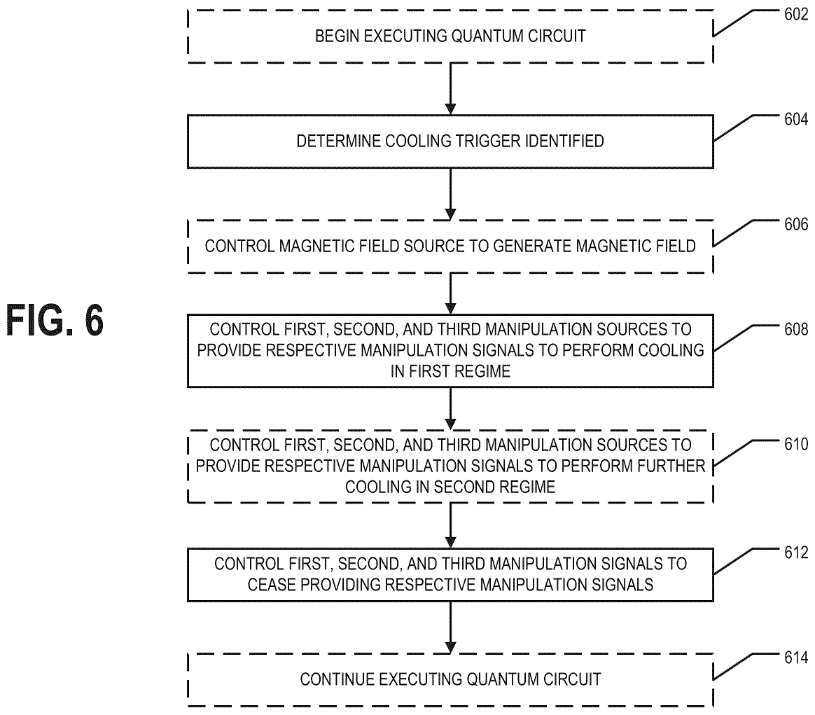

FIG. 6 provides a flowchart illustrating various processes, procedures, and/or the like to perform an SSD cooling operation on one or more object crystals confined by a confinement apparatus 50. The example embodiment shown in FIG. 6 corresponds to the performance of an SSD cooling operation by a QCCD-based quantum computer, such as quantum computer 110. In various embodiments, the processes, procedures, and/or the like illustrated in FIG. 6 are performed by a controller 30 of the quantum computer 110.

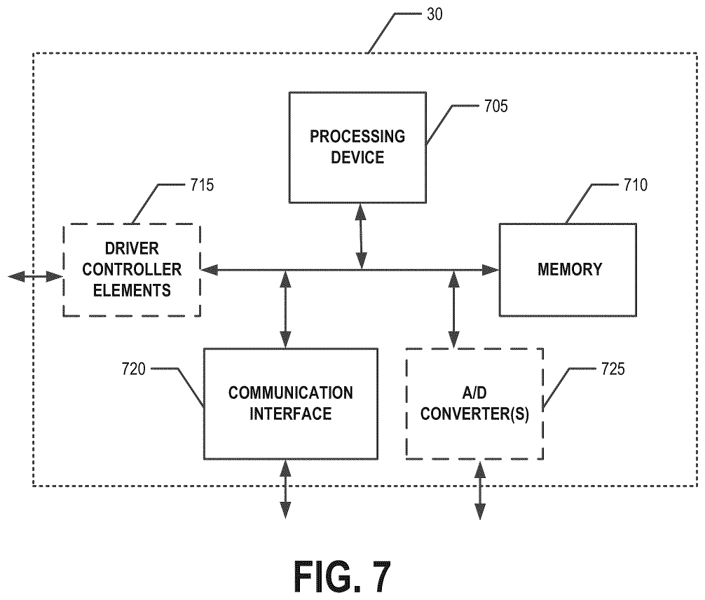

Starting at step/operation 602, the controller 30 causes the quantum computer 110 to begin performance and/or execution of a quantum circuit. For example, the controller 30 may receive (e.g., via communication interface 720, see FIG. 7) a quantum circuit program provided, for example, by a classical computing entity 10. The quantum circuit program may include executable instructions for performing at least a portion of a quantum circuit or may include program code that may be compiled (e.g., by a processing device 705 of the controller 30) to provide executable instructions for performing at least a portion of a quantum circuit. The controller may store the executable instructions in classical memory 710 of the controller 30 and execute at least a portion of the executable instructions via processing device 705 of the controller 30. Executing the at least a portion of the executable instructions via processing device 705 causes the controller 30 to use the driver controller elements 715 to control one or more components of the quantum computer 110 to cause the quantum computer 110 to begin performance and/or execution of the quantum circuit. For example, the controller 30 may control voltage sources of the quantum computer 110, manipulation sources 64, beam path systems 66, magnetic field generator 70, and/or the like to cause the quantum computer 110 to perform a controlled quantum state evolution of qubit objects of object crystals confined by the confinement apparatus 50.

At step/operation 604, the controller 30 determines that a cooling trigger has been identified. For example, as the controller 30 controls the quantum computer 110 and/or components thereof, the controller 30 (e.g., via processing device 705) determines that a cooling trigger has been identified. In an example embodiment, the cooling trigger is identified in response to performing a transport operation (e.g., a linear transport of an object crystal, transport of an object crystal through a junction of a two-dimensional confinement apparatus, re-ordering of components within an object crystal, combining object crystals, splitting object crystals, swapping object crystals, and/or the like) and determining that excess heat gained during the transport operation is to be removed from the object crystal. In an example embodiment, the cooling trigger is identified in preparation for the performance of a quantum gate. In an example embodiment, the cooling trigger is identified in response to detection of evidence that a collision occurred. For example, collision of an atomic object and/or qubit object with a background atom within the cryogenic and/or vacuum chamber 40 may result in the atomic object and/or qubit object being heated significantly. Therefore, when one or more calibration sensors provide sensor data that indicates a collision may have occurred, the controller 30 identifies the cooling trigger, in an example embodiment. In various embodiments, a variety of actions and/or planned actions may cause the controller 30 to determine that a cooling trigger has been identified. In various embodiments, the cooling trigger indicates that particular region 55 of the confinement apparatus 50 in which the cooling operation is to be performed. In an example embodiment, a cooling trigger is periodically identified (e.g., in response to a timer expiring and/or a counter reaching a particular value).

At step/operation 606, the controller 30 controls the magnetic field generator 70 to generate a magnetic field in the particular region 55 having a magnetic field direction and a particular amplitude. In an example embodiment, the magnetic field generator 70 is a permanent magnet and the controller 30 need not control the magnetic field generator 70. In an example embodiment, the magnetic field generator is an electromagnet and the controller 30 controls operation of a voltage and/or current source configured to provide a voltage and/or current signal to the magnetic field generator to cause the magnetic field generator 70 to generate a magnetic field in the particular region 55 having a magnetic field direction and a particular amplitude.

In an example embodiment, the magnetic field generator 70 is configured to generate and/or maintain a substantially stable magnetic field having a magnetic field direction and a particular amplitude throughout the operation of the quantum computer 110 and/or the performance of a quantum circuit and/or algorithm. Thus, the controller 30 controls the magnetic field generator 70 to maintain the magnetic field in the particular region 55 having the magnetic field direction and the particular amplitude, in an example embodiment.

At step/operation 608, the controller 30 controls operation of the first manipulation source 64A and/or first beam path system 66A, the second manipulation source 64B and/or second beam path system 66B, and one or more third manipulation sources 64C and/or one or more third beam path systems 66C to provide respective manipulation signals to cause SSD cooling to be performed in a first regime. For example, the controller 30 controls operation (e.g., via processing device 705, driver controller elements 715, and/or the like) of the first manipulation source 64A and/or first beam path system 66A to cause the first manipulation source 64A to generate and provide a first two-photon transition manipulation signal 230, 330, 430, 530 to the particular region 55 (e.g., via first beam path system 66A). The controller 30 further controls operation of the second manipulation source 64B and/or second beam path system 66B to cause the second manipulation source 64B to generate and provide a second two-photon transition manipulation signal 232, 332, 432, 532 to the particular region 55 (e.g., via the second beam path system 66B). The controller 30 further controls operation of one or more third manipulation sources 64C and/or third beam path systems 66C to cause each of the one or more third manipulation sources 64C to generate and provide a respective repump manipulation signal 240, 340, 440, 442, 540 to the particular region 55 (e.g., via respective third beam path systems 66C). In various embodiments, the controller 30 controls operation of one or more modulators (e.g., of respective beam path systems 66) to cause the respective manipulation signals to be provided and/or applied to the particular region 55 (e.g., via the respective beam path systems 66).

In various embodiments, the first two-photon transition manipulation signal, second two-photon transition manipulation signal, and one or more repump manipulation signals are provided as continuous beams (e.g., sheet laser beams, and/or pencil/focused laser beams).

In various embodiments, the first two-photon transition manipulation signal 230, 330, 430, 530, second two-photon transition manipulation signal 232, 332, 432, 532, and repump manipulation signal(s) 240, 340, 440, 442, 540 are provided to the confinement apparatus 50 as sheet beams. For example, the sheet beams are configured to be incident on multiple regions of the confinement apparatus 50 (e.g., the particular region 55 and one or more other regions of the confinement apparatus 50). In an example embodiment, the sheet beams are configured to be incident on each of the regions of the confinement apparatus 50.

In various embodiments, first two-photon transition manipulation signal 230, 330, 430, 530 is characterized by a first frequency (e.g., ω₁) that corresponds to red detuning of a single photon detuning Δ_{c} of a transition between a first ground state 212, 312, 412, 512 of an atomic object of the object crystal. The second two-photon transition manipulation signal 232, 332, 432, 532 is characterized by a second frequency (e.g., ω₂) that is configured to, with the first two-photon transition manipulation signal 230, 330, 430, 530, cause the atomic object to undergo a two-photon transition from the first ground state 212, 312, 412, 512 to a second ground state 214, 314, 414, 514. The second frequency is configured such that the two-photon transition from the first ground state 212, 312, 412, 512 to a second ground state 214, 314, 414, 514 is red detuned by a two-photon detuning δ. A repump manipulation signal 240, 340, 440, 442, 540 is characterized by a third frequency (e.g., ω₃) that corresponds to a red detuning of a repump detuning Δᵣ of a transition between a second ground state 214, 314, 414 514 to an excited state 220, 324, 524 and/or a repump state 452, 462. In an example embodiment, such as that illustrated in FIG. 4A, multiple repump manipulation signals may be used that are each characterized by a respective frequency corresponding to a respective repump transition. One or more of the respective frequencies of the multiple repump manipulation signals may be configured to be on-resonance (e.g., have a respective repump detuning of zero).

In various embodiments, the repump detuning Δᵣ is similar to the linewidth of the respective excited state 220, 324, 524 and/or repump state 452, 462. In various embodiments, the repump detuning Δᵣ is in a range of 0.2 to 10 times the linewidth of the respective excited state 220, 324, 524 and/or repump state 452, 462.

In various embodiments, the single photon detuning Δ_{c} is selected from one of a near detuned regime and a further detuned regime. In a near detuned regime, the single photon detuning Δ_{c} is in a range of 0.5 to 200 times or 0.5 to 500 times the linewidth of the respective excited state 220, 324, 424, 524. In the further detuned regime, the single photon detuning Δ_{c} is in a range of 500 to 100,000 times the linewidth of the respective excited state 220, 324, 424, 524.

In various embodiments, the two-photon detuning δ corresponds to respective motional frequencies of one or more motional modes of the atomic object and/or object crystal.

The controller 30 controls operation of the first manipulation source 64A and/or first beam path system 66A, the second manipulation source 64B and/or second beam path system 66B, and one or more third manipulation sources 64C and/or third beam path systems 66C to provide respective manipulation signals to cause SSD cooling to be performed in a first regime. For example, the controller 30 controls operation of the manipulation sources 64 to cause a cooling operation to be performed using a first single set of parameters. In various embodiments, a set of parameters includes the respective intensities of the first two-photon transition manipulation signal, the second two-photon transition manipulation signal, and one or more repump manipulation signals, the two-photon detuning δ, the single photon detuning Δ_{c}, and the repump detuning(s) Δᵣ.

In an example embodiment, the first regime is a near detuned regime where the single photon detuning Δ_{c} is in a range of 0.5 to 200 times or 0.5 to 500 times the linewidth of the respective excited state 220, 324, 424, 524. In an example embodiment, the first regime is a further detuned regime where the single photon detuning Δ_{c} is in a range of 500 to 100,000 times the linewidth of the respective excited state 220, 324, 424, 524.

For example, the controller 30 may control operation of manipulation sources 64 to cause an SSD cooling operation to be performed in a first regime and/or using a first set of parameters for a first cooling time. In various embodiments, the first cooling time is in a range of 25 μs to 2 ms. In various embodiments, the first cooling time is in a range of 50 to 125 μs. In various embodiments, the first cooling time is configured to cause cooling of one or more atomic objects and/or object crystals from a (possibly unknown) initial temperature to a first cooled temperature. In an example embodiment, the first cooled temperature is substantially equal to the minimum temperature obtainable via an SSD cooling operation of the first regime and/or using the first set of parameters. In an example embodiment, the first cooled temperature is greater than the minimum temperature obtainable via an SSD cooling operation of the first regime and/or using the first set of parameters, if such a first cooled temperature is appropriate for the application. In an example embodiment, the first cooled temperature is near the motional ground state of the atomic object and/or object crystal (e.g., n̅≈0.1). For example, the controller 30 determines when the first two-photon transition manipulation signal, second two-photon transition signal, and one or more repump manipulation signals have been incident on at least the particular region 55 for at least a first cooling time.

At optional step/operation 610, the controller 30 controls operation of the first manipulation source 64A and/or first beam path system 66A, the second manipulation source 64B and/or second beam path system 66B, and one or more third manipulation sources 64C and/or third beam path systems 66C to provide respective manipulation signals to cause SSD cooling to be performed in a second regime. For example, when the first cooled temperature is not appropriate for the application and/or not sufficiently close to the motional ground state of the atomic object and/or object crystal (e.g., n̅≈0.1), the controller 30 may cause an SSD cooling operation to be performed in a second regime and/or using a second set of parameters.

For example, the controller 30 controls operation (e.g., via processing device 705, driver controller elements 715, and/or the like) of the first manipulation source 64A and/or first beam path system 66A to cause the first manipulation source 64A to generate and provide a first two-photon transition manipulation signal 230, 330, 430, 530 to the particular region 55 (e.g., via first beam path system 66A). The controller 30 further controls operation of the second manipulation source 64B and/or second beam path system 66B to cause the second manipulation source 64B to generate and provide a second two-photon transition manipulation signal 232, 332, 432, 532 to the particular region 55 (e.g., via second beam path system 66B). The controller 30 further controls operation of one or more third manipulation sources 64C and/or third beam path systems 66C to cause each of the one or more third manipulation sources 64C to generate and provide a respective repump manipulation signal 240, 340, 440, 442, 540 to the particular region 55 (e.g., via respective third beam path systems 66C). In various embodiments, the first two-photon transition manipulation signal, second two-photon transition manipulation signal, and one or more repump manipulation signals are provided as continuous beams (e.g., sheet laser beams, and/or pencil/focused laser beams).

The controller 30 controls operation of the first manipulation source 64A and/or first beam path system 66A, the second manipulation source 64B and/or second beam path system 66B, and one or more third manipulation sources 64C and/or third beam path systems 66C to provide respective manipulation signals to cause SSD cooling to be performed in a second regime. For example, the controller 30 controls operation of the manipulation sources 64 to cause a cooling operation to be performed using a single second set of parameters. In various embodiments, a set of parameters includes the respective intensities of the first two-photon transition manipulation signal, the second two-photon transition manipulation signal, and one or more repump manipulation signals, the two-photon detuning δ, the single photon detuning Δ_{c}, and the repump detuning(s) Δᵣ.

In an example embodiment, the second regime is a further detuned regime where the single photon detuning Δ_{c} is in a range of 500 to 100,000 (or more) times the linewidth of the respective excited state 220, 324, 424, 524. In an example embodiment, the second regime is a near detuned regime where the single photon detuning Δ_{c} is in a range of 0.5 to 200 times or 0.5 to 500 times the linewidth of the respective excited state 220, 324, 424, 524. For example, in an example embodiment, the first regime is the near detuned regime and the second regime if the further detuned regime.

For example, the controller 30 may control operation of manipulation sources 64 to cause an SSD cooling operation to be performed in a second regime and/or using a second set of parameters for a second cooling time. In various embodiments, the second cooling time is in a range of 25 μs to 2 ms. In various embodiments, the second cooling time is in a range of 50 to 125 μs. In various embodiments, the second cooling time is configured to cause cooling of one or more atomic objects and/or object crystals from a first cooled temperature to a second cooled temperature. In an example embodiment, the second cooled temperature is a temperature that is appropriate for the application. In an example embodiment, the second cooled temperature is near the motional ground state of the atomic object and/or object crystal (e.g., n̅≈0.1). For example, the controller 30 determines when the first two-photon transition manipulation signal, second two-photon transition signal, and one or more repump manipulation signals have been incident on at least the particular region 55 for at least a second cooling time.

In various embodiments, one or more additional SSD cooling operations may be performed in respective additional regimes and/or using respective additional sets of parameters for respective additional cooling times. For example, in an example embodiment, a third set of parameters are used to perform an additional SSD cooling operation for a third cooling time and a fourth set of parameters are used to perform another additional SSD cooling operation for a fourth cooling time. For example, the SSD cooling operations are configured to cause the atomic objects and/or object crystals to be cooled to an appropriate temperature for the application.

At step/operation 612, the controller 30 controls the first manipulation source 64A and/or first beam path system 66A, the second manipulation source 64B and/or second beam path system 66B, and one or more third manipulation sources 64C and/or third beam path systems 66C to cause the first two-photon transition manipulation signal, the second two-photon transition manipulation signal, and the one or more repump manipulation signals to stop being applied to the particular region 55. For example, the controller 30 may (e.g., via the driver controller elements 715) cause the first manipulation source 64A and/or a first beam path system 66A to stop providing the first two-photon transition manipulation signal to the particular region 55, cause the second manipulation source 64B and/or a second beam path system 66B to stop providing the second two-photon transition manipulation signal to the particular region 55, and cause one or more third manipulation sources 64C and/or third beam path systems 66C to stop providing the repump manipulation signal(s) to the particular region 55. For example, the controller 30 may control one or more modulators (e.g., of respective beam path systems 66) to cause the respective manipulation signals to stop being provided and/or applied to the particular region 55.

At step/operation 614, the controller 30 controls various elements of the quantum computer 110 (e.g., voltage sources, manipulation sources 64, beam path systems 66, magnetic field generators 70, and/or the like) to continue performing and/or executing the quantum circuit. The controller may access executable instructions stored in classical memory 710 of the controller 30 and execute at least a portion of the executable instructions via processing device 705 of the controller 30. Executing the at least a portion of the executable instructions via processing device 705 causes the controller 30 to use the driver controller elements 715 to control one or more components of the quantum computer 110 to cause the quantum computer 110 to continue performing and/or executing the quantum circuit. For example, the controller 30 may control various elements of the quantum computer 110 to cause one or more object crystals to be transported into, out of, and/or within the particular region 55, perform one or more quantum gates on one or more qubit objects of respective object crystals, read a state of one or more qubit objects and/or components of object crystals, and/or the like.

### Technical Advantages

Conventional types of laser cooling include Doppler cooling, resolved sideband cooling, and EIT cooling. However, Doppler cooling is not able to cool to sufficiently low temperatures for various applications. Conventional sideband cooling that operates at large single photon detunings requires higher laser intensity than Doppler cooling or EIT cooling. In particular, conventional sideband cooling requires use of pencil and/or focused beams due to the required high laser intensity. This high laser intensity results in high levels of power consumption and significant wear on optical components of the system. Conventional sideband cooling also requires parameters that are tuned to the temperature of the atomic objects to cause efficient cooling. EIT cooling causes heating of atomic objects that are above a threshold temperature known as the “capture temperature,” which can lead to atomic objects and/or qubit objects being lost from the confinement apparatus. Moreover, while Doppler cooling and EIT are capable of multiple mode cooling, conventional sideband cooling is a single-mode cooling process. For example, for cooling multiple modes of the atomic objects and/or object crystals, conventional sideband cooling requires a series of single mode cooling operations, each with a distinct set of parameters.

As a result of EIT cooling's inability to cool atomic objects and/or object crystals having a temperature greater than the capture temperature and the technical demands associated with conventional sideband cooling, laser cooling is often performed as a multiple step process. For example, Doppler cooling may be used first to cool atomic objects and/or object crystals. However, as Doppler cooling cannot cool to sufficiently low temperatures for various applications, a second round of cooling using EIT cooling and/or conventional sideband cooling is used to cool atomic objects and/or object crystals to close to their motional ground state. Thus, conventional laser cooling techniques tend to be slow, technically challenging, and require multiple sets of parameters for cooling atomic objects and/or object crystals at different temperatures. Therefore, technical problems exist regarding how to laser cool atomic objects and/or object crystals efficiently in terms of time and energy consumption (e.g., power required to operate the lasers and/or manipulation sources). Additionally, the cost of the laser and/or amplification systems required for providing large amounts of laser power and the technical challenges of providing high power laser beams provide further technical problems. Moreover, technical problems exit regarding how to laser cool atomic objects and/or object crystals across a wide range of temperatures in a time and/or energy efficient manner.

Various embodiments provide technical solutions to these technical problems. For example, various embodiments provide a simultaneous sideband and Doppler (SSD) cooling technique. SSD cooling enables cooling of atomic objects and/or object crystals across a wide range of temperatures using a single set of parameters. For example, in various embodiments atomic objects and/or object crystals are quickly cooled to sub-Doppler temperatures (e.g., temperatures below the Doppler cooling limit) using a single set of parameters. Additionally, in various embodiments, the first two-photon transition manipulation signal, second two-photon transition manipulation signal, and/or repump manipulation signal are provided as sheet beams. This enables a large number of atomic objects and/or object crystals to be cooled (to sub-Doppler temperatures) simultaneously with moderate energy consumption. Moreover, in various embodiments, multiple motional modes of the atomic object and/or object crystal may be cooled simultaneously (which is not an available option conventional sideband cooling). This results in more time efficient cooling while still operating with only a single set of parameters. Therefore, various embodiments provide improvements to the technical fields of laser cooling, atomic systems that use laser cooling, and quantum computing.

### Exemplary Controller

In various embodiments, a quantum computer 110 comprises a controller 30 configured to control various elements of the quantum computer 110. In various embodiments, a controller 30 may be configured to cause a quantum computer 110 to perform various operations (e.g., computing operations such as gate operations, cooling operations, transport operations, qubit interaction operations, qubit measurement operations; leakage suppression/transformation operations; and/or the like). For example, the controller 30 may be configured to identify a cooling trigger, cause a cooling operation to be performed (e.g., an SSD cooling operation), control first, second, and/or third manipulation sources to provide respective manipulation signals, and/or the like. For example, the controller 30 may be configured to control a cryogenic system and/or vacuum system controlling the temperature and pressure within the cryogenic and/or vacuum chamber 40, manipulation sources 64, beam path systems 66, voltage sources configured to apply voltage signals to electrodes of the confinement apparatus 50, magnetic field generators 70, and/or systems controlling the environmental conditions (e.g., temperature, humidity, pressure, and/or the like) within the cryogenic and/or vacuum chamber 40 and/or configured to manipulate and/or cause a controlled evolution of quantum states of one or more atomic objects within the confinement apparatus 50.

As shown in FIG. 7, in various embodiments, the controller 30 may comprise various controller elements including processing device 705, memory 710, driver controller elements 715, a communication interface 720, analog-digital converter elements 725, and/or the like. For example, the processing device 705 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products.

In an example embodiment, the processing device 705 of the controller 30 comprises a clock and/or is in communication with a clock. For example, the clock may be used to determine when a periodic cooling trigger timer/counter has reached a particular value, when a first cooling time has elapsed, when a second cooling time has elapsed, and/or the like.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding to the qubits of the quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 710 (e.g., by a processing device 705) causes the controller 30 to perform one or more steps, operations, processes, procedures and/or the like described herein.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 705). In various embodiments, the driver controller elements 715 may enable the controller 30 to operate and/or control one or more manipulation sources 64, beam path systems 66, control one or more magnetic field generators 70, operate vacuum and/or cryogenic systems, and/or the like. In various embodiments, the drivers may be laser drivers; vacuum component drivers; voltage sources (e.g., AC voltage sources, arbitrary waveform generators (AWG), direct digital synthesizers (DDS), and/or the like); cryogenic and/or vacuum system component drivers; and/or the like. In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter elements 725 configured to receive signals from one or more optical receiver components, calibration sensors, and/or the like. For example, the controller 30 may receive measurements corresponding to conditions in particular regions 55 of the confinement apparatus 50 and/or corresponding to various qubit objects and/or object crystals via the analog-digital converter elements 725.

In various embodiments, the controller 30 may comprise a communication interface 720 for interfacing and/or communicating with a computing entity 10. For example, the controller 30 may comprise a communication interface 720 for receiving executable instructions, command sets, and/or the like from the computing entity 10 and providing output received from the quantum computer 110 (e.g., from an optical collection system or other measurement system) and/or the result of a processing the output to the computing entity 10. In various embodiments, the computing entity 10 and the controller 30 may communicate via a direct wired and/or wireless connection and/or one or more wired and/or wireless networks 20.

### Exemplary Computing Entity

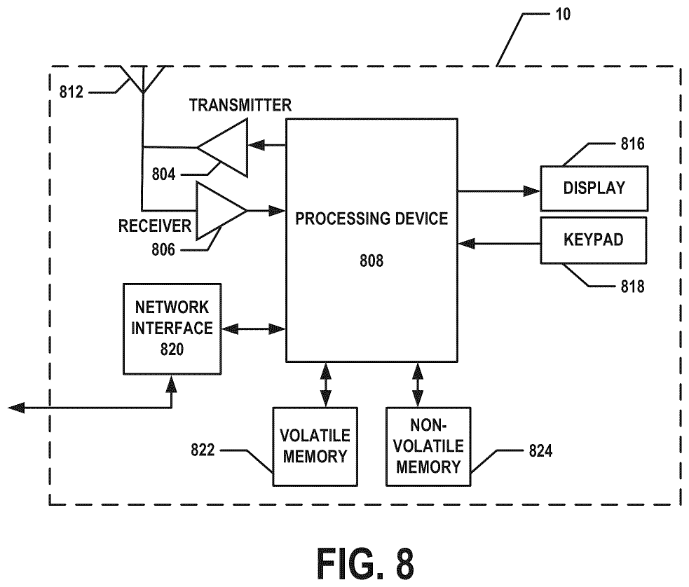

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110. For example, a user may operate a computing entity 10 to generate and/or program a quantum algorithm and/or quantum circuit that may be provided such that the controller 30 may receive the quantum algorithm and/or quantum circuit and cause the quantum computer 110 to perform the quantum algorithm and/or quantum circuit.

As shown in FIG. 8, a computing entity 10 can include an antenna 812, a transmitter 814 (e.g., radio), a receiver 806 (e.g., radio), and a processing device and/or element 808 that provides signals to and receives signals from the transmitter 814 and receiver 806, respectively. The signals provided to and received from the transmitter 814 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 comprises a network interface 820 configured to communicate via one or more wired and/or wireless networks 20. For example, in various embodiments, the computing entity 10 communicates with the controller 30 via the network interface 820.

The computing entity 10 may also comprise a user interface device comprising one or more user input/output interfaces (e.g., a display 816 and/or speaker/speaker driver coupled to a processing device and/or element 808 and a touch screen, keyboard, mouse, and/or microphone coupled to a processing device and/or element 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for cooling an atomic object confined by a confinement apparatus, the method comprising:
controlling, by a controller associated with the confinement apparatus, a first manipulation source to provide a first two-photon transition manipulation signal to a particular region of the confinement apparatus;
controlling, by the controller, a second manipulation source to provide a second two-photon transition manipulation signal to the particular region of the confinement apparatus; and
controlling, by the controller, a third manipulation source to provide at least one repump manipulation signal to the particular region of the confinement apparatus;
wherein:
the atomic object to be cooled is located in the particular region of the confinement apparatus,
the first two-photon transition manipulation signal and the second two-photon transition manipulation signal are collectively configured to drive a Raman transition that causes the atomic object to undergo a red sideband transition from a first ground state to a second ground state of the atomic object,
the at least one repump manipulation signal is configured to repump the atomic object from the second ground state to the first ground state via at least one excited state,
the at least one repump manipulation signal is red detuned from a transition from the second ground state to the at least one excited state by a repump detuning, and
the repump detuning is in a range of 0.2 to 10 times a linewidth of the at least one excited state.

2. The method of claim 1, wherein at least one of the first two-photon transition manipulation signal, the second two-photon transition manipulation signal, or the at least one repump manipulation signal are provided as sheet beams.

3. The method of claim 2, wherein the atomic object is one of a plurality of atomic objects confined by the confinement apparatus and the first two-photon transition manipulation signal, the second two-photon transition manipulation signal, and the at least one repump manipulation signal are collectively configured to cool the plurality of atomic objects simultaneously.

4. The method of claim 1, wherein a single photon detuning is a detuning between the first two-photon transition manipulation signal and the at least one excited state and the single photon detuning is in a range of 0.5 to 500 times the linewidth of the at least one excited state.

5. The method of claim 1, wherein respective intensities of the first two-photon manipulation signal, the second two-photon manipulation signal, the at least one repump manipulation signal, and the repump detuning are configured to enable multiple motional modes of the atomic object to be cooled simultaneously.

6. The method of claim 1, wherein collectively the first two-photon transition manipulation signal, the second two-photon transition manipulation signal, and the at least one repump manipulation signal cool the atomic object via continuous sideband cooling and Doppler cooling.

7. The method of claim 1, wherein a single photon detuning is a detuning between the first two-photon transition manipulation signal and the at least one excited state and the single photon detuning is in a range of 500 to 100,000 times the linewidth of the at least one excited state and the first two-photon transition manipulation signal, the second two-photon transition manipulation signal, and the at least one repump manipulation signal are provided as focused laser beams.

8. The method of claim 1, wherein the first two-photon transition manipulation signal and the second two-photon transition manipulation signal are not co-propagating.

9. The method of claim 1, wherein the atomic object is part of an object crystal comprising the atomic object and a qubit object and the atomic object is configured to sympathetically cool the qubit object.

10. The method of claim 1, wherein a single photon detuning is a detuning between the first two-photon transition manipulation signal and the at least one excited state, for a first time period, the single photon detuning is in a range of 0.5 to 100 times the linewidth of the at least one excited state, and for a second time period, the single photon detuning is in a range of 500 to 100,000 times the linewidth of the at least one excited state.

11. A method for cooling an atomic object confined by a confinement apparatus, the method comprising:
controlling, by a controller associated with the confinement apparatus, a first manipulation source to provide a first two-photon transition manipulation signal to a particular region of the confinement apparatus;
controlling, by the controller, a second manipulation source to provide a second two-photon transition manipulation signal to the particular region of the confinement apparatus; and
controlling, by the controller, a third manipulation source to provide at least one repump manipulation signal to the particular region of the confinement apparatus;
wherein:
the atomic object to be cooled is located in the particular region of the confinement apparatus,
the first two-photon transition manipulation signal and the second two-photon transition manipulation signal are collectively configured to cause the atomic object to undergo a red sideband transition from a first ground state to a second ground state of the atomic object,
the at least one repump manipulation signal is configured to repump the atomic object from the second ground state to the first ground state via at least one excited state,
a single photon detuning is a detuning between the first two-photon transition manipulation signal and the at least one excited state, and
the single photon detuning is in a range of 0.5 to 100 times a linewidth of the at least one excited state.

12. The method of claim 11, wherein the at least one repump manipulation signal is red detuned from a transition from the second ground state to the at least one excited state by a repump detuning, and the repump detuning is in a range of 0.2 to 10 times a linewidth of the at least one excited state.

13. The method of claim 11, wherein at least one of the first two-photon transition manipulation signal, the second two-photon transition manipulation signal, or the at least one repump manipulation signal are provided as sheet beams.

14. The method of claim 13, wherein the atomic object is one of a plurality of atomic objects confined by the confinement apparatus, the particular region is one of a plurality of regions defined at least in part by the confinement apparatus, the plurality of atomic objects are confined at one or more of the plurality of regions of the confinement apparatus, and the first two-photon transition manipulation signal, the second two-photon transition manipulation signal, and the at least one repump manipulation signal are collectively configured to cool the plurality of atomic objects simultaneously.

15. The method of claim 11, wherein respective intensities of the first two-photon manipulation signal, the second two-photon manipulation signal, the at least one repump manipulation signal, and the repump detuning are configured to enable multiple motional modes of the atomic object to be cooled simultaneously.

16. The method of claim 11, wherein collectively the first two-photon transition manipulation signal, the second two-photon transition manipulation signal, and the at least one repump manipulation signal are configured to cool the atomic object via continuous sideband cooling and Doppler cooling simultaneously.

17. The method of claim 11, wherein the first two-photon transition manipulation signal and the second two-photon transition manipulation signal are not co-propagating.

18. The method of claim 11, wherein the atomic object is part of an object crystal comprising the atomic object and a qubit object and the atomic object is configured to sympathetically cool the qubit object.

19. The method of claim 18, wherein the first two-photon transition manipulation signal, the second two-photon transition manipulation signal, and the at least one repump manipulation signal are configured to cool multiple motional modes of the object crystal simultaneously.

20. The method of claim 11, wherein the at least one repump manipulation signal is characterized by a frequency that is on resonance with a transition from the second ground state to the at least one excited state.
